(19) United States
(12) Patent Application Publication
(10) Pub. No.: US 2026/0335845 A1
(43) Pub. Date: Oct. 29, 2026

(54) APPARATUS FOR AND METHOD OF GENERATING A MIXTURE OF A FLUID AND AN ACTIVE AGENT

(71) Applicant: Quick Quack Car Wash Holdings, LLC, Roseville, CA (US)

(72) Inventors: Spencer Robert Drennan, Folsom, CA (US); Rodney Daniel Sparks, Roseville, CA (US)

(73) Assignee: Quick Quack Car Wash Holdings, LLC, Roseville, CA (US)

(21) Appl. No.: 19/657,225

(22) Filed: Apr. 24, 2026

Related U.S. Application Data
(60) Provisional application No. 63/794,590, filed on Apr. 25, 2025.

(51) Int. Cl. B01F 23/451; B01F 23/2326; B01F 23/235; B01F 25/31; B01F 25/312; B01F 35/21; B01F 35/221; B01F 35/71; B01F 35/83; B01F 101/00

(52) U.S. Cl. CPC B01F 23/451; B01F 23/2326; B01F 23/235; B01F 25/311; B01F 25/31114; B01F 25/312; B01F 35/2113; B01F 35/2132; B01F 35/2211; B01F 35/712; B01F 35/71805; B01F 35/833; B01F 2101/4505

(57) ABSTRACT

An apparatus for mixing a fluid and an active agent is disclosed. The apparatus includes a manifold body defining a designated channel extending from an inlet to an outlet, wherein the designated channel is configured to: receive a fluid; and combine the fluid with an active agent within the designated channel to generate and output a mixture at the outlet. The apparatus includes an injector system disposed within the designated channel, wherein the injector system is configured to increase a velocity of the fluid flowing through the designated channel and generate a suction force that draws the active agent into the designated channel. The apparatus includes at least one pressure sensor integrated with the manifold body, wherein the at least one pressure sensor is configured to monitor a pressure within the designated channel.

### CROSS-REFERENCE TO RELATED APPLICATIONS

This application claims the benefit of priority of U.S. Provisional Patent Application Serial No. 63/794,590, filed on Apr.25, 2025, and titled “SYSTEMS AND METHODS FOR DISPENSING SYSTEMS,” which is incorporated by reference herein in its entirety.

### FIELD OF THE INVENTION

The present invention generally relates to the field of dispensing systems. In particular, the present invention is directed to an apparatus for and method of generating a mixture of a fluid and an active agent.

### BACKGROUND

In many applications, it is desirable to generate a mixture of a fluid and an active agent. Conventional systems for mixing fluids and active agents can often increase system complexity, footprint, and potential leak points, and may require extensive assembly and maintenance. Accordingly, there remains a need for improved systems and apparatuses for addressing the challenges.

### SUMMARY OF THE DISCLOSURE

In some aspects, the techniques described herein relate to an apparatus for generating a mixture of a fluid and an active agent. The apparatus includes a manifold body defining a designated channel extending from an inlet to an outlet, wherein the designated channel is configured to receive a fluid, and combine the fluid with an active agent within the designated channel to generate and output a mixture at the outlet, an injector system disposed within the designated channel, wherein the injector system is configured to increase a velocity of the fluid flowing through the designated channel and generate a suction force that draws the active agent into the designated channel, and at least one pressure sensor integrated with the manifold body, wherein the at least one pressure sensor is configured to monitor a pressure within the designated channel.

In some aspects, the techniques described herein relate to a method of generating a mixture of a fluid and an active agent. The method includes receiving a fluid using a manifold body defining a designated channel extending from an inlet to an outlet, increasing a velocity of the fluid flowing through the designated channel and generating a suction force using an injector system disposed within the designated channel, combining the fluid with an active agent within the designated channel to generate a mixture, monitoring, using at least one pressure sensor integrated with the manifold body, a pressure within the designated channel, and outputting the mixture at the outlet.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates an exemplary embodiment of an apparatus for generating a mixture of a fluid and an active agent;

FIG. 2 illustrates an exemplary embodiment of a dispensing system;

FIG. 3 illustrates an exemplary embodiment of a dispensing station;

FIG. 4 illustrates a block diagram of an exemplary system for creating mixtures;

FIGS. 5A-5B are an exemplary embodiment of an injector system;

FIG. 6 illustrates an exploded view of the injector system;

FIGS. 7A-7B illustrate an exemplary embodiment of a soap channel;

FIG. 8 illustrates another exemplary embodiment of an injector system;

FIG. 9 illustrates an exemplary embodiment of a peristaltic pump;

FIGS. 10A-C illustrate an exemplary embodiment of a controller;

FIG. 11 illustrates a flow diagram of an exemplary embodiment of a method of generating a mixture of a fluid and an active agent; and

FIG. 12 illustrates a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods for generating a mixture of a fluid and an active agent. The apparatus includes a manifold body defining a designated channel extending from an inlet to an outlet, wherein the designated channel is configured to receive a fluid, and combine the fluid with an active agent within the designated channel to generate and output a mixture at the outlet, an injector system disposed within the designated channel, wherein the injector system is configured to increase a velocity of the fluid flowing through the designated channel and generate a suction force that draws the active agent into the designated channel, and at least one pressure sensor integrated with the manifold body, wherein the at least one pressure sensor is configured to monitor a pressure within the designated channel.

The method includes receiving a fluid using a manifold body defining a designated channel extending from an inlet to an outlet, increasing a velocity of the fluid flowing through the designated channel and generating a suction force using an injector system disposed within the designated channel, combining the fluid with an active agent within the designated channel to generate a mixture, monitoring, using at least one pressure sensor integrated with the manifold body, a pressure within the designated channel, and outputting the mixture at the outlet.

Exemplary embodiments illustrating aspects of the present disclosure are described below in the context of several specific examples.

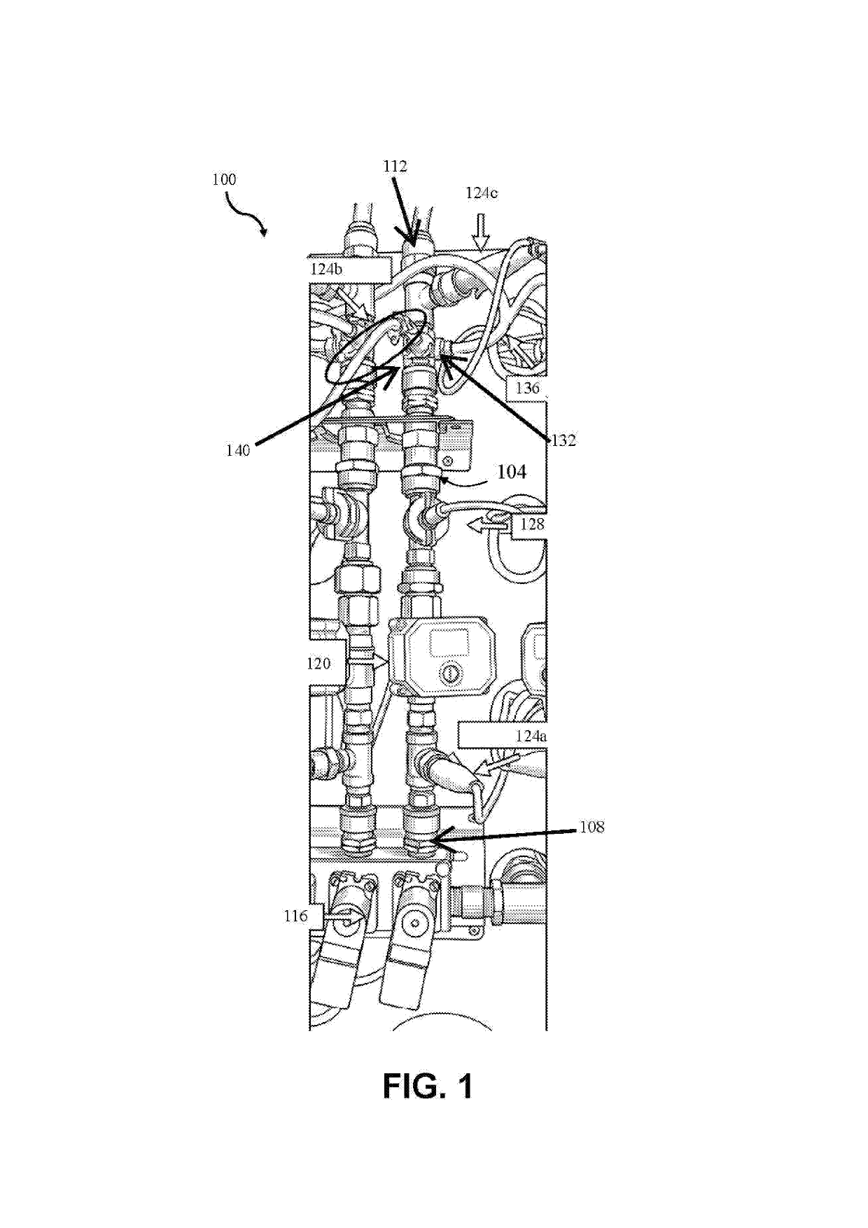

Referring now to FIG. 1, an exemplary embodiment of apparatus 100 for generating a mixture of a fluid and an active agent is illustrated. In one or more embodiments, apparatus 100 includes a manifold body 104 defining a designated channel extending from an inlet 108 to an outlet 112. For the purposes of this disclosure, “manifold body” is a unitary structure configured to receive fluidic material from more than one source or location. In some cases, manifold body may be configured to receive a fluid and an active agent and to generate a mixture of the fluid and the active agent. In some embodiments, mixture may be generated by combining a fluid and an active agent within a flow path. For the purposes of this disclosure, “mixture” is a combination of two or more substances. In some cases, substances may be physically intermingled without requiring a chemical reaction to form a new substance. In some embodiments, the mixture may include a homogeneous mixture in which the fluid and the active agent are uniformly distributed. In some embodiments, the mixture may include a heterogeneous mixture in which the fluid and the active agent are not uniformly distributed. For example, and without limitation, the mixture may include a solution in which the active agent is dissolved within the fluid or a dispersion in which the active agent is suspended within the fluid. In some embodiments, the mixture may include additional phases such as gas. For example, and without limitation, the mixture may include air bubbles dispersed within a liquid to form a foamed mixture. In some embodiments, the mixture may have properties that differ from the individual components. For example, and without limitation, the mixture may exhibit cleaning, disinfecting, or foaming characteristics based on the presence of the active agent. In some embodiments, the mixture may be defined by a ratio of the fluid to the active agent, wherein the ratio may determine a concentration of the active agent within the mixture. In some embodiments, the mixture may be generated continuously as the fluid and the active agent flow together or may be generated intermittently based on operation of apparatus 100.

With continued reference to FIG. 1, for the purposes of this disclosure, “designated channel” is an internal passage within a manifold body configured to convey fluid and facilitate mixing with an active agent or secondary fluid. In one or more embodiments, designated channel may be consistent with soap channel. In some embodiments, designated channel may comprise a continuous internal passage extending through manifold body 104 from inlet 108 to outlet 112. In some embodiments, designated channel may be configured to transport a fluid along a defined flow path while providing a region within which mixing may occur. In some embodiments, designated channel may include a single, uninterrupted bore. In some embodiments, designated channel may include a straight-through bore, a curved conduit, or a multi-segment passage. For example, and without limitation, designated channel may include a cylindrical bore extending longitudinally through manifold body 104 or intersecting passages defining a mixing region. In some embodiments, designated channel may include multiple connected segments forming a composite flow path. For example, and without limitation, designated channel may include a first segment aligned with inlet 108 and a second segment aligned with outlet 112, wherein the first segment and the second segment are connected by an intermediate region. In some embodiments, designated channel may include a varying cross-sectional geometry along a length of designated channel. In some embodiments, designated channel may include a uniform diameter along its length. In some embodiments, designated channel may include one or more sections having reduced or enlarged diameters. For example, and without limitation, designated channel may include a narrowed portion configured to increase fluid velocity and a widened portion configured to reduce fluid velocity. In some embodiments, designated channel may be configured to define one or more regions that facilitate interaction between a fluid and an active agent. In some embodiments, designated channel may include a region configured to promote mixing through fluid motion. For example, and without limitation, designated channel may include internal contours or curvature configured to induce directional changes in fluid flow. In some embodiments, designated channel may include internal surface features. In some embodiments, designated channel may include a smooth internal surface configured to reduce pressure loss. In some embodiments, designated channel may include a textured or roughened internal surface configured to increase fluid interaction. For example, and without limitation, designated channel may include grooves, ridges, or patterned surface features. In some embodiments, designated channel may be configured to support different flow regimes. In some embodiments, designated channel may support laminar flow conditions. In some embodiments, designated channel may support turbulent flow conditions. For example, and without limitation, designated channel may be dimensioned to achieve a Reynolds number corresponding to a desired flow regime. In some embodiments, designated channel may be configured to accommodate different fluid types and operating conditions. In some embodiments, designated channel may be configured to withstand high-pressure fluid flow. In some embodiments, designated channel may be configured to accommodate fluids having different viscosities. For example, and without limitation, designated channel may be sized to maintain a desired flow rate for fluids having varying viscosities. In some embodiments, designated channel may be formed using one or more manufacturing processes. For example, and without limitation, designated channel may be formed by drilling, milling, casting, or additive manufacturing. In some embodiments, designated channel may be formed as part of a monolithic structure of manifold body 104. In some embodiments, designated channel may be configured to be maintained or cleaned. In some embodiments, designated channel may be configured to allow fluid flushing. For example, and without limitation, designated channel may be configured to permit passage of a cleaning fluid to remove accumulated material.

With continued reference to FIG. 1, for the purposes of this disclosure, “inlet” is an opening or interface through which a fluid enters a manifold body. Designated channel is configured to receive a fluid and combine the fluid with an active agent within designated channel to generate and output a mixture at outlet 112. In some embodiments, inlet 108 may be configured to provide a fluid into manifold body 104, wherein inlet 108 may be positioned at an upstream portion of manifold body 104 relative to designated channel, or inlet 108 may be positioned at a downstream portion of manifold body 104 depending on a configuration of designated channel. In some embodiments, inlet 108 may include an opening, port, or interface configured to receive the fluid from an external source. In some embodiments, inlet 108 may include a geometry configured to facilitate fluid entry into designated channel, wherein inlet 108 may comprise a cylindrical opening aligned with designated channel, or inlet 108 may comprise an angled or offset opening configured to direct fluid into designated channel. For example, and without limitation, inlet 108 may be oriented along a longitudinal axis of designated channel or may be oriented at an angle to redirect flow into designated channel. In some embodiments, inlet 108 may include a connection feature configured to couple to a fluid supply line, wherein inlet 108 may include threads, barbs, or quick-connect features. For example, and without limitation, inlet 108 may include a threaded interface configured to engage with a corresponding threaded fitting of a supply conduit. In some embodiments, inlet 108 may be configured to accommodate different fluid pressures and flow rates, wherein inlet 108 may be sized to allow high-pressure fluid entry and maintain a desired flow profile as the fluid enters designated channel. For example, and without limitation, inlet 108 may include a tapered entry region configured to reduce turbulence at entry. In some embodiments, inlet 108 may include internal features configured to condition the fluid prior to entering designated channel, wherein inlet 108 may include a straightening section configured to align fluid flow. For example, and without limitation, inlet 108 may include internal vanes or flow-directing features configured to reduce swirl.

With continued reference to FIG. 1, for the purposes of this disclosure, “outlet” is an opening or interface through which a mixture exits a manifold body. In some embodiments, outlet 112 may be configured to discharge a mixture from manifold body 104, wherein outlet 112 may be positioned at a downstream portion of manifold body 104 relative to designated channel, or outlet 112 may be positioned at an upstream portion of manifold body 104 depending on a configuration of designated channel. In some embodiments, outlet 112 may include a geometry configured to facilitate discharge of the mixture, wherein outlet 112 may comprise a cylindrical opening aligned with designated channel or may include an expanded or tapered region configured to modify exit conditions. For example, and without limitation, outlet 112 may include a diverging section configured to decelerate the mixture prior to discharge. In some embodiments, outlet 112 may include a connection feature configured to couple to a downstream conduit, wherein outlet 112 may include threads, barbs, or quick-connect interfaces. For example, and without limitation, outlet 112 may be configured to connect to a hose, nozzle, or distribution line. In some embodiments, outlet 112 may be configured to direct the mixture toward a target location, wherein outlet 112 may include a directional feature configured to guide flow. For example, and without limitation, outlet 112 may include a nozzle portion configured to shape a discharge pattern.

With continued reference to FIG. 1, in some embodiments, inlet 108 and outlet 112 may be aligned with one another or offset relative to one another, wherein inlet 108 and outlet 112 may define a straight-through configuration or a bent or curved flow path through manifold body 104. For example, and without limitation, inlet 108 and outlet 112 may be arranged coaxially or may be arranged at an angle relative to one another. In some embodiments, inlet 108 and outlet 112 may be configured to support different operating conditions, wherein inlet 108 may receive fluid at a higher pressure than a pressure at outlet 112. In some embodiments, inlet 108 and outlet 112 may be formed as integral features of manifold body 104 during manufacturing, wherein inlet 108 and outlet 112 may be machined, molded, or additively manufactured as part of manifold body 104.

With continued reference to FIG. 1, apparatus 100 may include a fluid providing valve 116 fluidly coupled to inlet 108. For the purposes of this disclosure, “fluid providing valve” is an electrically actuated valve configured to selectively permit or block fluid flow. Fluid providing valve 116 is configured to selectively provide the fluid to manifold body 104. In some embodiments, fluid providing valve 116 may be positioned upstream of inlet 108 and may receive fluid from a pressurized supply line. As a non-limiting example, fluid providing valve 116 may transition between an open state permitting flow and a closed state preventing flow in response to an electrical signal. In some embodiments, fluid providing valve 116 may be configured to selectively provide a fluid to manifold body 104 by controlling flow into designated channel. In some cases, fluid providing valve 116 may include an electrically actuated valve that transitions between at least an open state permitting fluid flow and a closed state preventing fluid flow in response to an electrical signal. As a non-limiting example, fluid providing valve 116 may include solenoid valve, piezo valve, and the like. In some embodiments, fluid providing valve 116 may be positioned along a fluid supply path upstream of designated channel, wherein fluid providing valve 116 may control whether fluid is introduced into manifold body 104. In some embodiments, fluid providing valve 116 may include an electromagnetic coil, a movable plunger, and a valve seat, wherein energizing the electromagnetic coil causes the plunger to move relative to the valve seat to permit fluid flow, and de-energizing the electromagnetic coil causes the plunger to return to a position restricting fluid flow. For example, and without limitation, fluid providing valve 116 may include a normally closed configuration in which fluid flow is blocked in the absence of electrical power and permitted when the fluid providing valve 116 is energized, or fluid providing valve 116 may include a normally open configuration in which fluid flow is permitted in the absence of electrical power and blocked when energized. In some embodiments, fluid providing valve 116 may be configured for rapid actuation to enable precise control of fluid delivery timing. For example, and without limitation, fluid providing valve 116 may be actuated in response to a control signal from a controller to initiate or terminate fluid flow within a predetermined time interval. In some embodiments, fluid providing valve 116 may be configured to operate under a range of fluid pressures, wherein fluid providing valve 116 may be selected based on pressure ratings corresponding to a fluid supply. In some embodiments, fluid providing valve 116 may include internal sealing elements configured to prevent leakage when in a closed state. For example, and without limitation, fluid providing valve 116 may include elastomeric seals or seats configured to provide a fluid-tight seal. In some embodiments, fluid providing valve 116 may be configured to be controlled by a controller, wherein fluid providing valve 116 may receive electrical signals corresponding to operational conditions. In some embodiments, fluid providing valve 116 may be actuated based on sensor data to enable or disable fluid flow. For example, and without limitation, fluid providing valve 116 may be closed in response to detection of an unsuitable fluid condition or opened when a mixing operation is initiated. In some embodiments, fluid providing valve 116 may be configured to operate in coordination with other flow control components to provide controlled delivery of fluid into designated channel.

With continued reference to FIG. 1, in some embodiments, components of apparatus 100 may be described as being fluidly coupled to one another to define a fluid communication path. For the purposes of this disclosure, “fluidly coupled” is a relationship between two or more components in which a fluid is capable of flowing between the components, either directly or through one or more intermediate structures, such that the components are in fluid communication. In some embodiments, fluidly coupled components may be directly connected without intervening elements, wherein a first component is physically joined to a second component such that fluid flows between them through a shared interface. For example, and without limitation, a conduit may be directly attached to a port such that fluid passes from the conduit into the port without passing through additional components. In some embodiments, fluidly coupled components may be indirectly connected, wherein one or more intermediate components are positioned between the components while still permitting fluid flow. For example, and without limitation, a valve, sensor, or conduit may be positioned between two components, and the components may still be fluidly coupled because fluid flows through the intermediate component. In some embodiments, fluidly coupled components may be connected via rigid structures such as pipes or channels. In some embodiments, fluidly coupled components may be connected via flexible structures such as hoses or tubing. For example, and without limitation, fluidly coupled components may be connected using elastomeric tubing configured to transport fluid between the components. In some embodiments, fluidly coupled components may be connected using detachable or permanent interfaces. For example, and without limitation, fluidly coupled components may be connected using threaded fittings, barbed connectors, compression fittings, or quick-connect interfaces. In some embodiments, fluidly coupled components may be arranged such that fluid flows in a unidirectional manner. In some embodiments, fluidly coupled components may permit bidirectional flow depending on operating conditions. For example, and without limitation, a check valve may be included within a fluidly coupled path to restrict flow to a single direction. In some embodiments, fluidly coupled components may be configured to maintain a sealed fluid path to prevent leakage. For example, and without limitation, seals, gaskets, or O-rings may be used to maintain fluid integrity between fluidly coupled components. In some embodiments, fluidly coupled components may be configured to accommodate different fluid pressures and flow rates while maintaining fluid communication between the components.

With continued reference to FIG. 1, in some embodiments, fluid may be configured to be received at inlet 108 and conveyed through designated channel for combination with an active agent. For the purposes of this disclosure, “fluid” is a substance capable of flowing and conforming to the shape of a containing structure. In some cases, fluid may include liquids, gases, or mixtures thereof. In some embodiments, the fluid may include a liquid. In some embodiments, the fluid may include water. For example, and without limitation, the fluid may include potable water, deionized water, distilled water, or recycled water. In some embodiments, the fluid may include a solution or mixture of multiple substances. For example, and without limitation, the fluid may include water combined with dissolved minerals, salts, or additives. In some embodiments, the fluid may comprise a gas. For example, and without limitation, the fluid may include air or another compressible gas introduced into the system. In some embodiments, the fluid may include a multiphase substance including both liquid and gas components. For example, and without limitation, the fluid may include a liquid containing entrained air bubbles. In some embodiments, the fluid may be provided at a range of pressures. In some embodiments, the fluid may be supplied at a relatively high pressure to facilitate movement through designated channel. For example, and without limitation, the fluid may be provided at pressures sufficient to induce flow through internal passages of manifold body 104. In some embodiments, the fluid may be provided at a controlled flow rate. In some embodiments, the fluid may have a viscosity that affects flow characteristics within designated channel. For example, and without limitation, the fluid may comprise a low-viscosity liquid such as water or a higher-viscosity liquid such as a solution containing suspended materials. In some embodiments, the fluid may include additional properties that influence interaction with an active agent. In some embodiments, the fluid may have a pH value within a specified range. In some embodiments, the fluid may contain impurities or dissolved substances that affect compatibility with the active agent. For example, and without limitation, the fluid may include ions, organic compounds, or particulates. In some embodiments, the fluid may be conditioned prior to entering designated channel. For example, and without limitation, the fluid may be filtered, heated, cooled, or otherwise treated prior to introduction. In some embodiments, the fluid may be selected based on a desired application of the mixture generated at outlet 112. For example, and without limitation, the fluid may be selected to serve as a carrier for a cleaning agent, a disinfectant, or another active substance. In some embodiments, the fluid may be compatible with the active agent to ensure effective mixing and performance of the resulting mixture.

With continued reference to FIG. 1, apparatus 100 may include a modulating valve 120 fluidly coupled to inlet 108. For the purposes of this disclosure, “modulating valve” is a valve configured to regulate a magnitude of fluid flow through variable positioning of a flow restriction element. Modulating valve 120 may be configured to regulate a flow of the fluid into designated channel. In some embodiments, modulating valve 120 may comprise a proportional valve configured to continuously vary flow rate. For example, and without limitation, modulating valve 120 may adjust an internal aperture to control the flow of the fluid entering designated channel. In some embodiments, modulating valve 120 may be configured to regulate a flow of a fluid into designated channel by varying a degree of flow restriction within a fluid path. In some embodiments, modulating valve 120 may be positioned upstream of designated channel and downstream of inlet 108, wherein modulating valve 120 may control a magnitude of fluid flow delivered into manifold body 104. As a non-limiting example, modulating valve 120 may be positioned between a first pressure sensor 124aand a flow sensor as described in detail below. In some embodiments, modulating valve 120 may include a movable flow control element configured to adjust an effective flow area. For example, and without limitation, modulating valve 120 may include a needle, diaphragm, gate, or ball configured to vary a passage through which the fluid flows. In some embodiments, modulating valve 120 may be configured to operate in response to a control signal received from controller, wherein modulating valve 120 may adjust fluid flow based on sensor data. In some embodiments, modulating valve 120 may be configured to provide fine-grained control of flow rate to achieve a desired operating condition within designated channel. For example, and without limitation, modulating valve 120 may be adjusted incrementally to maintain a target flow rate measured by flow sensor 128. In some embodiments, modulating valve 120 may comprise a proportional valve configured to continuously vary flow rate in proportion to an input signal, or modulating valve 120 may comprise an electronically controlled valve configured to adjust position based on an electrical control signal. For example, and without limitation, modulating valve 120 may include a motor-driven actuator or a piezoelectric actuator configured to position a flow control element. In some embodiments, modulating valve 120 may be configured to operate under a range of pressures and flow conditions, wherein modulating valve 120 may be configured to maintain a desired downstream pressure or flow rate within designated channel. For example, and without limitation, modulating valve 120 may adjust flow in response to pressure variations detected within manifold body 104. In some embodiments, modulating valve 120 may be configured to cooperate with fluid providing valve 116 to control fluid delivery, wherein fluid providing valve 116 may provide on/off control and modulating valve 120 may provide variable flow control. For example, and without limitation, fluid providing valve 116 may be opened to initiate flow and modulating valve 120 may then adjust the flow rate to a desired level. In some embodiments, modulating valve 120 may be configured to reduce fluctuations in flow, wherein modulating valve 120 may provide smoothing or stabilization of fluid flow entering designated channel. For example, and without limitation, modulating valve 120 may dampen pressure spikes or flow oscillations. In some embodiments, modulating valve 120 may be constructed from materials selected to withstand exposure to the fluid, wherein modulating valve 120 may include metal, polymer, or composite materials compatible with the fluid and operating conditions. In some embodiments, modulating valve 120 may be configured to be calibrated to achieve specific flow characteristics, wherein modulating valve 120 may be adjusted during setup or operation to match desired system performance. For example, and without limitation, modulating valve 120 may be tuned to achieve a specific flow rate corresponding to a desired mixture output.

With continued reference to FIG. 1, apparatus 100 may include a flow sensor 128 fluidly coupled downstream of modulating valve 120. For the purposes of this disclosure, “flow sensor” is a sensing device configured to measure a flow rate of a fluid. Flow sensor 128 may be configured to measure a flow rate of the fluid. In some embodiments, flow sensor 128 may be configured to measure a flow rate of a fluid within a fluid path and generate corresponding sensor data. In some embodiments, flow sensor 128 may generate sensor data corresponding to volumetric flow rate, mass flow rate, or velocity of the fluid entering designated channel. As a non-limiting example, flow sensor 128 may include a turbine flow meter, an ultrasonic flow sensor, or a thermal mass flow sensor. In some embodiments, flow sensor 128 may be positioned along a fluid path upstream of designated channel or downstream of a flow control component, wherein flow sensor 128 may monitor fluid entering manifold body 104. In some embodiments, flow sensor 128 may be configured to provide real-time measurements of fluid flow. For example, and without limitation, flow sensor 128 may generate a signal proportional to a rate at which fluid passes through a sensing region. In some embodiments, flow sensor 128 may comprise a turbine flow sensor, wherein rotation of a turbine element corresponds to a flow rate of the fluid. In some embodiments, flow sensor 128 may comprise an ultrasonic flow sensor configured to measure flow based on propagation of ultrasonic signals through the fluid. In some embodiments, flow sensor 128 may comprise a thermal mass flow sensor configured to determine flow rate based on heat transfer characteristics of the fluid. For example, and without limitation, flow sensor 128 may detect changes in temperature distribution caused by fluid movement to determine flow rate. In some embodiments, flow sensor 128 may be configured to operate across a range of fluid types, pressures, and viscosities, wherein flow sensor 128 may be selected based on compatibility with a particular fluid. In some embodiments, flow sensor 128 may be configured to output data to controller, wherein controller may process the data to monitor system performance. For example, and without limitation, controller may adjust operation of one or more valves based on a measured flow rate to maintain a desired operating condition. In some embodiments, flow sensor 128 may be configured to detect anomalies in fluid flow, wherein flow sensor 128 may indicate conditions such as reduced flow, blockage, or unexpected increases in flow rate. For example, and without limitation, flow sensor 128 may detect a deviation from an expected flow profile and provide corresponding data to controller. In some embodiments, flow sensor 128 may be integrated into manifold body 104 or may be coupled to a conduit external to manifold body 104. In some embodiments, flow sensor 128 may be configured to maintain minimal pressure loss while measuring flow, wherein flow sensor 128 may include a low-profile sensing structure that does not substantially obstruct fluid flow.

With continued reference to FIG. 1, in some embodiments, flow rate may be used to characterize movement of a fluid through a fluid path. For the purposes of this disclosure, “flow rate” is a quantity of a fluid that passes through a defined cross-sectional area per unit time. In some embodiments, flow rate may be expressed as a volumetric flow rate representing a volume of fluid per unit time. For example, and without limitation, flow rate may be expressed in units of liters per minute, gallons per minute, or cubic meters per second. In some embodiments, flow rate may be expressed as a mass flow rate representing a mass of fluid per unit time. For example, and without limitation, flow rate may be expressed in units of kilograms per second or pounds per minute. In some embodiments, flow rate may be related to a velocity of the fluid and a cross-sectional area through which the fluid flows. For example, and without limitation, flow rate may be determined based on a product of fluid velocity and cross-sectional area of a passage. In some embodiments, flow rate may vary based on operating conditions such as pressure, temperature, and fluid properties. For example, and without limitation, flow rate may increase with increased pressure differential across a passage or may decrease with increased fluid viscosity. In some embodiments, flow rate may be monitored to control operation of apparatus 100, wherein a controller may adjust one or more components based on measured flow rate to maintain a desired operating condition.

With continued reference to FIG. 1, apparatus 100 may include a soap port 132 formed in manifold body 104. For the purposes of this disclosure, “soap port” is an opening in a manifold body configured to receive an active agent. Soap port 132 is configured to receive the active agent. In some embodiments, soap port 132 may be coupled to tubing or a conduit delivering the active agent from a reservoir. In some embodiments, soap port 132 may be formed as an aperture extending from an external surface of manifold body 104 to an internal region. In some embodiments, soap port 132 may be configured to fluidly communicate with an internal passage such that the active agent is introduced into the fluid. For example, and without limitation, soap port 132 may intersect an internal passage at a defined location to enable delivery of the active agent into a flowing stream. In some embodiments, soap port 132 may be configured to receive the active agent from a reservoir or supply line. In some embodiments, soap port 132 may include a connection feature configured to couple to a conduit delivering the active agent. For example, and without limitation, soap port 132 may include threads, barbs, compression fittings, or quick-connect interfaces to facilitate connection to tubing or hoses. In some embodiments, soap port 132 may be oriented at an angle relative to an internal flow path to influence introduction of the active agent. For example, and without limitation, soap port 132 may be oriented substantially perpendicular to a primary flow direction or may be oriented at an acute angle to promote entrainment of the active agent. In some embodiments, soap port 132 may include an internal passage configured to guide the active agent into the fluid path. In some embodiments, soap port 132 may include a restricted opening configured to control a rate at which the active agent is introduced. For example, and without limitation, soap port 132 may include a nozzle or orifice configured to meter the active agent.

With continued reference to FIG. 1, a check valve assembly is disposed at soap port 132 and is configured to permit one-way flow of the active agent into designated channel. For the purposes of this disclosure, “check valve assembly” is a valve structure configured to permit fluid flow in a first direction and restrict fluid flow in an opposite direction. In some embodiments, check valve assembly may be positioned at an interface where an active agent is introduced into a fluid path, wherein check valve assembly may prevent fluid from flowing backward toward a source of the active agent. In some embodiments, check valve assembly may include a movable sealing element configured to transition between an open position permitting forward flow and a closed position preventing reverse flow. For example, and without limitation, check valve assembly may include a spring-biased poppet, ball, diaphragm, or flap configured to move in response to a pressure differential. In some embodiments, check valve assembly may be configured such that a forward flow pressure overcomes a biasing force to open the valve, while a reverse pressure causes the valve to close and seal against a valve seat. For the purposes of this disclosure, “spring-biased valve” is a valve comprising a movable sealing element and a spring configured to apply a force to the movable sealing element to maintain the valve in a default position until a threshold pressure is applied. For example, and without limitation, a spring-biased valve may include a spring configured to urge a sealing element toward a closed position, wherein forward flow compresses the spring to permit passage of fluid. In some embodiments, check valve assembly may be configured to provide a cracking pressure corresponding to a minimum pressure required to initiate opening of the valve. In some embodiments, check valve assembly may be configured to minimize leakage when in a closed state, wherein sealing surfaces may be designed to provide a fluid-tight seal. For example, and without limitation, check valve assembly may include elastomeric seals or precision-machined surfaces configured to reduce leakage. In some embodiments, check valve assembly may be configured to operate with different types of fluids, including liquids having varying viscosities or containing particulates. For example, and without limitation, check valve assembly may be selected to accommodate fluids containing dissolved or suspended materials without clogging. In some embodiments, check valve assembly may be integrated within a structure or may be provided as a separate component coupled to the structure. In some embodiments, check valve assembly may be configured to respond rapidly to changes in flow direction, thereby preventing contamination or backflow. For example, and without limitation, check valve assembly may close automatically when forward flow ceases or when reverse pressure is detected. In some embodiments, check valve assembly may be configured to protect upstream components from exposure to downstream fluid conditions by restricting reverse flow.

With continued reference to FIG. 1, in some embodiments, active agent may be configured to be combined with a fluid to produce a mixture having one or more functional properties. For the purposes of this disclosure, “active agent” is a substance that, when combined with a fluid, imparts a functional, chemical, or physical effect to the resulting mixture. In some embodiments, the active agent may comprise a liquid substance. In some embodiments, the active agent may comprise a cleaning agent. For example, and without limitation, the active agent may include a detergent, soap, or degreasing solution configured to remove contaminants. In some embodiments, the active agent may comprise a disinfecting or sanitizing agent. For example, and without limitation, the active agent may include an antimicrobial solution, a bleach-based compound, or an alcohol-based solution configured to reduce or eliminate microorganisms. In some embodiments, the active agent may comprise a chemical additive configured to modify properties of the fluid. For example, and without limitation, the active agent may include a surfactant configured to reduce surface tension, a foaming agent configured to generate foam, or a corrosion inhibitor configured to protect surfaces. In some embodiments, the active agent may comprise a concentrated formulation configured to be diluted by the fluid to achieve a desired concentration. For example, and without limitation, the active agent may be stored in a concentrated form and introduced into the fluid at a controlled ratio to produce a usable solution. In some embodiments, the active agent may have properties such as viscosity, density, or reactivity that influence mixing behavior. For example, and without limitation, the active agent may comprise a higher-viscosity liquid that requires sufficient suction or flow conditions to be entrained into the fluid. In some embodiments, the active agent may be selected based on compatibility with the fluid. In some embodiments, the active agent may react with the fluid to produce a desired effect, or may remain chemically stable within the fluid. For example, and without limitation, the active agent may be selected to avoid undesirable reactions such as precipitation or degradation when combined with the fluid. In some embodiments, the active agent may be delivered from a reservoir or supply system and introduced into a fluid path at a controlled rate. In some embodiments, the active agent may be configured to produce a mixture having cleaning, foaming, disinfecting, or other functional characteristics upon combination with the fluid. In some embodiments, soap port 132 may be configured to withstand exposure to the active agent, wherein materials of soap port 132 may be selected for chemical compatibility. In some embodiments, soap port 132 may be formed integrally with manifold body 104 during manufacturing or may be formed as a separate component coupled to manifold body 104. In some embodiments, soap port 132 may be configured to allow maintenance or cleaning, wherein soap port 132 may be accessible for flushing or inspection.

With continued reference to FIG. 1, in some embodiments, a soap tube 136 may be configured to transport an active agent from a source to soap port 132. For the purposes of this disclosure, “soap tube” is a conduit configured to convey an active agent between components of a system. In some embodiments, the soap tube 136 may comprise flexible tubing configured to accommodate routing within a system. In some embodiments, the soap tube 136 may comprise a rigid conduit configured to maintain a fixed geometry. For example, and without limitation, the soap tube 136 may include polymer tubing, elastomeric hose, or metal tubing. In some embodiments, the soap tube 136 may be configured to withstand exposure to the active agent, wherein materials of the soap tube 136 may be selected based on chemical compatibility. In some embodiments, the soap tube 136 may be configured to deliver the active agent at a controlled flow rate. For example, and without limitation, the soap tube 136 may be coupled to a pump or flow control component to regulate delivery. In some embodiments, the soap tube 136 may be configured to be removably connected to soap port 132 to facilitate maintenance or replacement.

With continued reference to FIG. 1, apparatus 100 includes an injector system 140 disposed within designated channel. For the purposes of this disclosure, “injector system” is a structure configured to induce flow of an active agent into a fluid stream by generating a pressure differential. Injector system 140 is configured to increase a velocity of the fluid flowing through designated channel and generate a suction force that draws the active agent from soap port 132 into designated channel. In some embodiments, injector system 140 may be positioned at a mixing region within designated channel. In some embodiments, injector system 140 may include a venturi injector including an orifice configured to increase the velocity of the fluid flowing through designated channel. For the purposes of this disclosure, “venturi injector” is a structure configured to generate a pressure differential that draws another fluid into a moving fluid stream. In some cases, venturi injector may include a converging section, a throat region, and a diverging section arranged to increase a velocity of a fluid and decrease a pressure at the throat region. For the purposes of this disclosure, “orifice” is a restriction having a defined opening through which a fluid flows, the restriction being configured to alter at least one of a velocity, pressure, and flow rate of the fluid. As a non-limiting example, the venturi injector may include a converging section, a throat region, and a diverging section configured to create a localized pressure drop. In some embodiments, injector system 140 may be configured such that the pressure at the throat region is lower than a pressure at soap port 132, thereby causing the active agent to be drawn into designated channel due to the pressure differential. In some embodiments, injector system 140 may be configured to regulate an amount of suction generated based on a geometry of the orifice and surrounding flow path. For example, and without limitation, a diameter of the throat region may be selected to control a magnitude of the pressure drop and corresponding suction force. In some embodiments, injector system 140 may be configured to operate across a range of flow rates, wherein a higher fluid velocity may result in increased suction force and increased entrainment of the active agent. In some embodiments, injector system 140 may include multiple stages or regions configured to progressively increase fluid velocity and enhance mixing. For example, and without limitation, injector system 140 may include a first constriction region followed by a second constriction region to amplify suction effects. In some embodiments, injector system 140 may be configured to introduce the active agent into the fluid stream at a location corresponding to a region of reduced pressure and increased turbulence. In some embodiments, injector system 140 may be configured to promote mixing downstream of the injection point. For example, and without limitation, injector system 140 may be configured to generate vortices or turbulent flow patterns that enhance dispersion of the active agent within the fluid. In some embodiments, injector system 140 may be formed integrally within designated channel as part of manifold body 104. In some embodiments, injector system 140 may be formed as a separate insert or component positioned within designated channel. For example, and without limitation, injector system 140 may comprise a removable insert configured to be replaced or serviced. In some embodiments, injector system 140 may be configured to operate without moving parts, thereby reducing mechanical complexity and increasing reliability. In some embodiments, injector system 140 may be configured to minimize pressure loss downstream of the mixing region while still providing sufficient suction to draw the active agent. For example, and without limitation, a diverging section of injector system 140 may be configured to recover pressure following the throat region. In some embodiments, injector system 140 may be configured to accommodate different types of active agents having varying viscosities, wherein geometry of injector system 140 may be selected to ensure sufficient suction for entrainment of higher-viscosity substances. In some embodiments, injector system 140 may be configured to provide consistent entrainment of the active agent under varying operating conditions, thereby enabling controlled and repeatable mixing within designated channel.

With continued reference to FIG. 1, apparatus 100 includes at least one pressure sensor 124a-c integrated with manifold body 104. For the purposes of this disclosure, “pressure sensors” are sensing devices configured to measure pressure at respective locations within an apparatus. Pressure sensors 124a-c are configured to monitor a pressure associated with at least one of inlet 108, soap port 132, and outlet 112. In some embodiments, pressure sensors 124a-c may include a first pressure sensor 124a disposed at inlet 108. In some cases, pressure sensors 124a-c may include a first pressure sensor 124a disposed between inlet 108 and modulating valve 120, a second pressure sensor 124b disposed at soap port 132, and a third pressure sensor 124c disposed at outlet 112. As a non-limiting example, pressure sensors 124a-c may include piezoresistive sensors or capacitive pressure sensors. In some embodiments, pressure sensors 124a-c may be configured to generate electrical signals corresponding to measured pressure values, wherein the electrical signals may be transmitted to controller for processing. In some embodiments, pressure sensors 124a-c may be configured to provide real-time monitoring of pressure conditions within manifold body 104. For example, and without limitation, pressure sensors 124a-c may continuously measure pressure during operation to detect changes in flow conditions. In some embodiments, pressure sensors 124a-c may be configured to detect pressure differentials between locations within apparatus 100. For example, and without limitation, a difference between measurements from first pressure sensor 124a and third pressure sensor 124c may be used to determine a pressure drop across designated channel. For example, and without limitation, pressure sensor 124b or any pressure sensors 124a-c may be configured to measure the health of the venturi action of venturi injector or injection system 140 and processor may determine if the venturi injector or injection system 140 is properly pulling soap into the dilution block. In some embodiments, pressure sensors 124a-c may be configured to facilitate detection of abnormal operating conditions. For example, and without limitation, pressure sensors 124a-c may detect a pressure increase indicative of a blockage or a pressure decrease indicative of a leak. In some embodiments, pressure sensors 124a-c may be configured to assist in regulating operation of apparatus 100, wherein controller may adjust one or more components based on measured pressure values. For example, and without limitation, controller may modify operation of a valve in response to pressure data to maintain a desired operating condition. In some embodiments, pressure sensors 124a-c may be configured to operate across a range of pressures and fluid types, wherein pressure sensors 124a-c may be selected based on compatibility with operating conditions. In some embodiments, pressure sensors 124a-c may be integrated within manifold body 104 such that sensing elements are positioned in fluid communication with internal passages. In some embodiments, pressure sensors 124a-c may be mounted externally and connected via pressure ports. For example, and without limitation, pressure sensors 124a-c may be coupled to pressure taps formed in manifold body 104. In some embodiments, pressure sensors 124a-c may be configured to have a response time suitable for detecting rapid pressure changes. For example, and without limitation, pressure sensors 124a-c may be configured to detect transient pressure spikes or drops during operation. In some embodiments, pressure sensors 124a-c may be configured to provide data for calibration or diagnostics of apparatus 100, wherein pressure measurements may be used to evaluate performance or identify maintenance needs.

With continued reference to FIG. 1, apparatus 100 may include a pump fluidly coupled to soap port 132. For the purposes of this disclosure, “pump” is a device configured to move fluid from one location to another by imparting energy to the fluid. The pump may be configured to regulate a flow rate of the active agent delivered to soap port 132. In some embodiments, the pump may draw the active agent from a reservoir and deliver the active agent at a controlled rate. For example, and without limitation, the pump may include a peristaltic pump, diaphragm pump, or gear pump. In some embodiments, the pump may be configured to provide a variable flow rate of the active agent based on an operational condition of apparatus 100. In some embodiments, the pump may be configured to operate in response to a control signal received from controller, wherein the pump may adjust delivery of the active agent based on sensor data. For example, and without limitation, controller may increase or decrease a pumping rate to maintain a desired ratio between the fluid and the active agent. In some embodiments, the pump may be configured to operate continuously or intermittently. For example, and without limitation, the pump may be activated only during a mixing operation or may operate continuously to maintain a supply of the active agent. In some embodiments, the pump may be configured to generate a pressure sufficient to overcome resistance within a fluid path leading to soap port 132. In some embodiments, the pump may be configured to cooperate with a pressure differential generated within designated channel to facilitate delivery of the active agent. For example, and without limitation, the pump may provide an initial flow of the active agent while an injector system 140 further draws the active agent into designated channel. In some embodiments, the pump may be configured to handle active agents having different viscosities or compositions. For example, and without limitation, the pump may be selected to transport low-viscosity liquids or higher-viscosity substances without degradation of performance. In some embodiments, the pump may include materials compatible with the active agent to prevent chemical degradation. In some embodiments, the pump may be configured to provide accurate metering of the active agent, wherein the pump may deliver a predetermined volume per unit time. For example, and without limitation, the pump may be calibrated to deliver a specific volume of the active agent corresponding to a desired mixture concentration. In some embodiments, the pump may include internal components such as rotors, diaphragms, or rollers configured to move the active agent. In some embodiments, the pump may be configured to minimize pulsation in flow to provide a steady delivery of the active agent. For example, and without limitation, the pump may include damping features or multi-stage operation to reduce fluctuations in flow. In some embodiments, the pump may be configured to be integrated within manifold body 104 or positioned externally and fluidly coupled to soap port 132. In some embodiments, the pump may be configured to be removable or serviceable, wherein the pump may be replaced or maintained without disassembling manifold body 104.

With continued reference to FIG. 1, apparatus 100 may include a controller communicatively coupled to at least one of flow sensor 128, pressure sensors 124a-c, fluid providing valve 116, or modulating valve 120. For the purposes of this disclosure, “controller” is a computing device configured to receive data and generate control signals. The controller may be configured to control operation of at least one of fluid providing valve 116 or modulating valve 120 based on sensor data. In some embodiments, controller may include one or more processors, memory devices, and communication interfaces configured to process and transmit data. In some embodiments, controller may be configured to execute instructions stored in memory to perform control operations. For example, and without limitation, controller may execute a control algorithm configured to maintain a desired flow rate or pressure within apparatus 100. In some embodiments, controller may be configured to receive real-time data from one or more sensors and dynamically adjust operation of components in response to changing conditions. For example, and without limitation, controller may modify operation of fluid providing valve 116 or modulating valve 120 based on detected variations in flow rate or pressure. In some embodiments, controller may be configured to implement feedback control, wherein controller may compare measured values to target values and adjust operation of one or more components to reduce a difference between the measured values and the target values. In some embodiments, controller may be configured to store historical data associated with operation of apparatus 100. For example, and without limitation, controller may record flow rates, pressure values, or operational states for diagnostic or optimization purposes. In some embodiments, controller may be configured to communicate with external systems or devices. For example, and without limitation, controller may transmit data to a remote system or receive control inputs from an external interface. In some embodiments, controller may be configured to initiate or terminate operation of apparatus 100 based on predefined conditions. For example, and without limitation, controller may close fluid providing valve 116 when a fault condition is detected or may enable operation when system parameters are within acceptable ranges. In some embodiments, controller may be configured to coordinate operation of multiple components to achieve a desired system performance. For example, and without limitation, controller may simultaneously adjust flow control and monitor pressure to maintain consistent mixture generation. In some embodiments, controller may be implemented as a dedicated hardware device or as part of a distributed control system. For example, and without limitation, controller may be implemented as a microcontroller, programmable logic controller, or embedded computing system.

With continued reference to FIG. 1, in some embodiments, the controller may determine a ratio of the fluid to the active agent based on the sensor data. For example, and without limitation, the controller may adjust modulating valve 120 to maintain a target dilution ratio. In some embodiments, a ratio of the fluid to the active agent may be used to characterize a relative proportion of the fluid and the active agent within a mixture. For the purposes of this disclosure, “ratio of the fluid to the active agent” is a quantitative relationship representing an amount of the fluid relative to an amount of the active agent in a mixture. In some embodiments, the ratio may be expressed as a volumetric ratio. For example, and without limitation, the ratio of the fluid to the active agent may be expressed as a ratio of volumes, such as 10:1, indicating ten units of fluid for every one unit of active agent. In some embodiments, the ratio may be expressed as a mass-based ratio representing a mass of the fluid relative to a mass of the active agent. For example, and without limitation, the ratio may be expressed in units such as kilograms of fluid per kilogram of active agent. In some embodiments, the ratio may be determined based on flow rates of the fluid and the active agent. For example, and without limitation, the ratio may be calculated by dividing a flow rate of the fluid by a flow rate of the active agent. In some embodiments, the ratio may be adjusted to achieve a desired concentration or performance characteristic of the mixture. For example, and without limitation, a higher proportion of the active agent may increase cleaning effectiveness, while a lower proportion may reduce chemical usage. In some embodiments, the ratio may be controlled by controller based on sensor data. For example, and without limitation, controller may adjust one or more components to maintain a target ratio during operation. In some embodiments, the ratio may vary dynamically in response to changing operating conditions or system requirements.

With continued reference to FIG. 1, in some embodiments, sensor data may be generated by one or more sensing devices and utilized by controller to monitor and control operation of apparatus 100. For the purposes of this disclosure, “sensor data” is information produced by one or more sensors that represents a measured parameter associated with operation of a system. The sensor data may include a measured physical parameter. In some embodiments, sensor data may include measurements corresponding to flow rate, pressure, temperature, or other measurable properties of a fluid or system components. For example, and without limitation, sensor data may include a signal representing a flow rate measured by flow sensor 128 or a pressure value measured by one or more of pressure sensors 124a-c. In some embodiments, sensor data may be generated in real time and continuously updated during operation of apparatus 100. In some embodiments, sensor data may be transmitted to controller in the form of electrical signals, digital values, or encoded information. For example, and without limitation, sensor data may comprise analog voltage signals, current signals, or digital communication signals corresponding to measured parameters. In some embodiments, sensor data may be processed by controller to derive additional information. For example, and without limitation, controller may calculate a ratio of fluid to active agent based on flow rate and pressure data. In some embodiments, sensor data may be used to detect changes in operating conditions. For example, and without limitation, sensor data may indicate a deviation from a target flow rate, a pressure fluctuation, or an abnormal system condition. In some embodiments, sensor data may be used to implement feedback control, wherein controller may adjust operation of one or more components in response to differences between measured values and desired values. In some embodiments, sensor data may be stored for later analysis or diagnostics. For example, and without limitation, historical sensor data may be analyzed to identify trends, performance characteristics, or maintenance needs. In some embodiments, sensor data may be filtered, averaged, or otherwise processed to reduce noise or improve accuracy. For example, and without limitation, controller may apply smoothing or calibration techniques to sensor data prior to using the data for control decisions. In some embodiments, sensor data may be used to trigger alerts or protective actions. For example, and without limitation, controller may initiate a shutdown or adjust system operation when sensor data indicates a fault condition or unsafe parameter.

With continued reference to FIG. 1, controller may include circuitry such as without limitation a processor communicatively connected to a memory; for instance, circuitry may include and/or be included in a computing device. Processor may include any computing device as described in this disclosure, including without limitation a microcontroller, microprocessor, digital signal processor (DSP) and/or system on a chip (SoC) as described in this disclosure. Processor may include, be included in, and/or communicate with a mobile device such as a mobile telephone or smartphone. Processor may include a single computing device operating independently, or may include two or more computing device operating in concert, in parallel, sequentially or the like; two or more computing devices may be included together in a single computing device or in two or more computing devices. Processor may interface or communicate with one or more additional devices as described below in further detail via a network interface device. Network interface device may be utilized for connecting processor to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor may include but is not limited to, for example, a computing device or cluster of computing devices in a first location and a second computing device or cluster of computing devices in a second location. Processor may include one or more computing devices dedicated to data storage, security, distribution of traffic for load balancing, and the like. Processor may distribute one or more computing tasks as described below across a plurality of computing devices of computing device, which may operate in parallel, in series, redundantly, or in any other manner used for distribution of tasks or memory between computing devices. Processor may be implemented, as a non-limiting example, using a “shared nothing” architecture.

With continued reference to FIG. 1, memory may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein processor may access the information from primary memory.

With continued reference to FIG. 1, as used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, processor may be designed and/or configured to perform any method, method step, or sequence of method steps in any embodiment described in this disclosure, in any order and with any degree of repetition. For instance, processor may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, manifold body 104 may include one or more connection interfaces formed as part of manifold body 104. For the purposes of this disclosure, “connection interfaces” are structural features configured to enable coupling between a manifold body and external conduits. The connection interfaces may be configured for removable connection of manifold body 104 to at least one of a fluid supply line or a downstream conduit. In some embodiments, the connection interfaces may include threaded fittings, barbed connectors, or quick-connect couplings. In some embodiments, the connection interfaces may be integrally formed with manifold body 104 as part of a unitary structure. In some embodiments, the connection interfaces may be formed as separate components coupled to manifold body 104. For example, and without limitation, a threaded insert or fitting may be secured within an opening of manifold body 104 to define a connection interface. In some embodiments, the connection interfaces may be configured to provide a fluid-tight seal when coupled to a corresponding conduit. For example, and without limitation, the connection interfaces may include sealing features such as O-rings, gaskets, or tapered threads configured to prevent leakage. In some embodiments, the connection interfaces may be configured to allow rapid attachment and detachment of external components. For example, and without limitation, quick-connect couplings may include a push-to-connect mechanism that enables a conduit to be secured or released without tools. In some embodiments, the connection interfaces may be configured to support repeated connection and disconnection cycles without degradation of sealing performance. In some embodiments, the connection interfaces may be configured to accommodate different conduit types and sizes. For example, and without limitation, the connection interfaces may be adapted to connect to flexible tubing, rigid piping, or hose assemblies. In some embodiments, the connection interfaces may be configured to maintain alignment between manifold body 104 and connected conduits. For example, and without limitation, the connection interfaces may include guiding features or alignment surfaces that ensure proper positioning during coupling. In some embodiments, the connection interfaces may be configured to withstand mechanical loads and fluid pressures encountered during operation. For example, and without limitation, the connection interfaces may be reinforced or dimensioned to resist deformation or failure under pressure. In some embodiments, the connection interfaces may be configured to facilitate installation and maintenance of apparatus 100, wherein the connection interfaces enable modular assembly and replacement of components without requiring disassembly of manifold body 104.

With continued reference to FIG. 1, in some embodiments, components of apparatus 100 may be configured to be detachably coupled to one another or to external systems. For the purposes of this disclosure, “removable connection” is a coupling between two components that permits separation and reattachment of the components without permanent alteration or destruction of either component. In some embodiments, a removable connection may be achieved using mechanical interfaces that allow repeated connection and disconnection. For example, and without limitation, a removable connection may include threaded fittings, quick-connect couplings, snap-fit interfaces, or compression fittings configured to enable tool-assisted or tool-less engagement and disengagement. In some embodiments, a removable connection may be configured to maintain a fluid-tight seal while connected and to allow disconnection for maintenance, replacement, or reconfiguration.

With continued reference to FIG. 1, in some embodiments, a fluid supply line may be coupled to inlet 108 to provide fluid to apparatus 100. For the purposes of this disclosure, “fluid supply line” is a conduit configured to transport a fluid from a source to a system or component. In some embodiments, the fluid supply line may include rigid piping, flexible tubing, or hose assemblies. For example, and without limitation, the fluid supply line may be connected to a pressurized water source and deliver fluid to manifold body 104. In some embodiments, the fluid supply line may be configured to withstand pressures, flow rates, and environmental conditions associated with operation.

With continued reference to FIG. 1, in some embodiments, a downstream conduit may be coupled to outlet 112 to receive a mixture from apparatus 100. For the purposes of this disclosure, “downstream conduit” is a conduit configured to transport a fluid or mixture away from a system or component toward a subsequent destination or application point. In some embodiments, the downstream conduit may comprise rigid piping, flexible tubing, or hose assemblies configured to direct the mixture to a point of use. For example, and without limitation, the downstream conduit may deliver the mixture to a spray nozzle, distribution manifold, or application surface. In some embodiments, the downstream conduit may be configured to maintain integrity of the mixture during transport, including preserving flow characteristics or pressure conditions.

With continued reference to FIG. 1, apparatus 100 may include an air supply manifold fluidly coupled to manifold body 104. For the purposes of this disclosure, “air supply manifold” is a structure configured to deliver pressurized air to a fluid flow path. The air supply manifold may be configured to introduce air into designated channel such that the mixture generated at outlet 112 may include air bubbles or foamed characteristics. In some embodiments, the air supply manifold may include one or more air injection ports communicating with designated channel. For example, and without limitation, pressurized air may be introduced downstream of injector system 140 to generate foam. In some embodiments, the air supply manifold may be configured to distribute air to multiple locations along designated channel. In some embodiments, the air supply manifold may include internal passages configured to direct air from an air source to one or more injection ports. For example, and without limitation, the air supply manifold may include branching channels configured to evenly distribute air across multiple injection points. In some embodiments, the air supply manifold may be configured to regulate a pressure or flow rate of air introduced into designated channel. In some embodiments, the air supply manifold may include one or more flow control elements configured to adjust air delivery. For example, and without limitation, the air supply manifold may include valves, restrictors, or regulators configured to control air flow. In some embodiments, the air supply manifold may be configured to introduce air in a manner that promotes mixing with the fluid and active agent. For example, and without limitation, the air injection ports may be oriented to create turbulence or to entrain air into the flowing mixture. In some embodiments, the air supply manifold may be configured to generate different bubble sizes or foam characteristics. For example, and without limitation, the air supply manifold may include fine orifices configured to produce small bubbles or larger openings configured to produce larger bubbles. In some embodiments, the air supply manifold may be configured to operate with a pressurized air source such as a compressor or compressed air line. In some embodiments, the air supply manifold may be configured to maintain a consistent air supply under varying operating conditions. For example, and without limitation, the air supply manifold may compensate for fluctuations in air pressure to maintain consistent foaming characteristics. In some embodiments, the air supply manifold may be formed integrally with manifold body 104 or may be provided as a separate component coupled to manifold body 104. In some embodiments, the air supply manifold may be configured to be removable or serviceable, wherein the air supply manifold may be detached for maintenance or replacement. In some embodiments, the air supply manifold may be configured to withstand environmental conditions associated with operation, including exposure to moisture, chemicals, or pressure variations.

With continued reference to FIG. 1, in some embodiments, a mixture generated within apparatus 100 may include air bubbles or foamed characteristics. For the purposes of this disclosure, “air bubbles characteristics” are properties of a mixture associated with the presence of discrete gas pockets dispersed within a liquid phase. In some cases, the gas pockets may be surrounded by the liquid and remain distinguishable as individual bubbles. In some embodiments, air bubbles characteristics may include parameters such as bubble size, bubble distribution, and bubble density within the mixture. For example, and without limitation, the mixture may include small, uniformly distributed bubbles or larger, irregularly distributed bubbles depending on operating conditions. In some embodiments, air bubbles characteristics may influence visual appearance, flow behavior, and interaction of the mixture with a surface. For example, and without limitation, the presence of air bubbles may increase surface coverage or enhance mechanical agitation during application. In some embodiments, the mixture may exhibit foamed characteristics. For the purposes of this disclosure, “foamed characteristics” are properties of a mixture in which gas is dispersed within a liquid in a manner that forms a stable or semi-stable structure of interconnected or dispersed bubbles, resulting in a foam. In some embodiments, foamed characteristics may include parameters such as foam stability, foam density, and persistence of the foam over time. For example, and without limitation, the mixture may form a thick, stable foam that adheres to a surface or a lighter foam that dissipates more rapidly. In some embodiments, foamed characteristics may be influenced by properties of the fluid and active agent, including presence of surfactants. For example, and without limitation, a surfactant within the active agent may stabilize air-liquid interfaces and promote formation of foam. In some embodiments, foamed characteristics may enhance effectiveness of the mixture in a given application. For example, and without limitation, foam may increase contact time with a surface, improve coverage, or provide visual indication of application.

With continued reference to FIG. 1, apparatus 100 may include a pH meter configured to measure a pH of the fluid prior to entry of the fluid into designated channel. For the purposes of this disclosure, “pH meter” is a sensing device configured to determine an acidity or alkalinity level of a fluid. The pH meter may be communicatively coupled to a controller. The controller may be configured to determine, based on the pH, whether the fluid is suitable for combination with the active agent and to control operation of at least one of fluid providing valve 116 or modulating valve 120 based on the determination. In some embodiments, a determination of whether the fluid is “suitable” for combination with the active agent may be based on whether one or more properties of the fluid fall within predefined criteria associated with effective and safe mixing. For the purposes of this disclosure, “suitable” is a condition in which a fluid satisfies one or more predefined thresholds or ranges that enable combination with an active agent without causing undesirable effects. In some embodiments, suitability may be based on whether the pH of the fluid falls within a predetermined pH range. For example, and without limitation, a fluid may be considered suitable when the pH is within a range that prevents degradation, precipitation, or reduced effectiveness of the active agent. In some embodiments, suitability may further include maintaining compatibility between the fluid and the active agent such that the resulting mixture performs as intended. For example, and without limitation, a fluid having a pH outside of the predetermined range may be considered unsuitable if it would chemically react with or neutralize the active agent. In some embodiments, suitability may be determined dynamically by controller based on measured pH values relative to stored threshold values. In some embodiments, the controller may prevent introduction of the fluid into designated channel if the pH is outside of a predefined range. For example, and without limitation, the controller may maintain the fluid within a predetermined pH range to prevent adverse interaction with the active agent. In some embodiments, the pH meter may comprise an electrochemical sensor including a sensing electrode and a reference electrode configured to generate a signal corresponding to hydrogen ion concentration of the fluid. In some embodiments, the pH meter may be configured to provide continuous or periodic measurements of the fluid. For example, and without limitation, the pH meter may continuously monitor the pH of the fluid as it flows or may sample the fluid at defined intervals. In some embodiments, the pH meter may be positioned within a flow path upstream of designated channel or within a sampling chamber fluidly coupled to the flow path. In some embodiments, the pH meter may be configured to output sensor data in the form of an electrical signal representing the measured pH value. For example, and without limitation, the pH meter may generate a voltage signal proportional to the pH level, which may be transmitted to controller. In some embodiments, the pH meter may be configured to operate across a range of fluid types and conditions, wherein the pH meter may be selected based on compatibility with temperature, pressure, and chemical composition of the fluid. In some embodiments, the pH meter may include calibration features to maintain measurement accuracy. For example, and without limitation, the pH meter may be calibrated using reference solutions having known pH values. In some embodiments, the pH meter may be configured to detect deviations from a target pH range and provide corresponding data to controller. In some embodiments, the pH meter may be used to prevent undesirable chemical interactions between the fluid and the active agent. For example, and without limitation, the controller may restrict operation of apparatus 100 when the pH meter indicates a value that may result in degradation, precipitation, or reduced effectiveness of the active agent. In some embodiments, the pH meter may be integrated into manifold body 104 or may be implemented as a separate component fluidly coupled to the fluid path. In some embodiments, the pH meter may be configured to be removable or serviceable for maintenance or replacement.

With continued reference to FIG. 1, additional disclosure related to any components of apparatus 100, including but not limited to dilution block, designated channel, manifold body 104, fluid providing valve 116, modulating valve 120, flow sensor 128, soap port 132, injector system 140, pressure sensors 124a-c, pump, controller, air supply manifold, and pH meter, may be found in U.S. Provisional Patent Application Serial No. 63/794,590, filed on Apr. 25, 2025, and titled “SYSTEMS AND METHODS FOR DISPENSING SYSTEMS,” which is incorporated by reference herein in its entirety.

With continued reference to FIG. 1, in some embodiments, apparatus 100, including an integrated dilution block, provides a custom-machined manifold that consolidates the critical components of chemical mixing into a single physical unit. In one or more embodiments, apparatus 100 can integrate a venturi injector, check valves, and pressure sensors into one solid block, thus desirably replacing the traditional assembly of multiple threaded pipe fittings and PVC parts. Advantageously, such designs can significantly reduce the physical footprint and eliminate potential leak points, creating a robust “plug-and-play” component that simplifies assembly and maintenance while ensuring consistent vacuum generation for chemical draw.

With continued reference to FIG. 1, in some embodiments, apparatus 100 can provide an integrated soap channel and metering manifold that comprises a unified structural apparatus designed to streamline fluid delivery by replacing complex, multi-component valve assemblies with a single consolidated block. In one or more embodiments, desirably such designs can physically integrate an ultrasonic flow meter directly into a piping structure and combine essential ports, including the fluid inlet, chemical induction soap port, and pressure sensor mount, into a specific manifold configuration. Advantageously, one or more embodiments as disclosed herein, can utilize the venturi nozzle’s precisely sized orifice as a primary flow control mechanism, effectively creating a passive, fixed-rate delivery system that drastically simplifies hardware requirements while ensuring consistent chemical mixing.

With continued reference to FIG. 1, in some embodiments, apparatus 100 may be implemented within a vehicle wash or car wash facility to generate mixtures of fluid and active agents for cleaning operations. In some embodiments, apparatus 100 may be integrated into a wash bay, tunnel system, or mobile washing unit to provide controlled delivery of cleaning solutions to vehicles. For example, and without limitation, apparatus 100 may generate a foamed cleaning mixture applied to vehicle surfaces to enhance contaminant removal. In some embodiments, integration of multiple components within manifold body 104 may reduce plumbing complexity and minimize potential leak points within the facility. In some embodiments, apparatus 100 may enable consistent mixture generation despite variations in water pressure or flow conditions commonly encountered in car wash environments. For example, and without limitation, apparatus 100 may maintain a desired ratio of fluid to active agent to ensure uniform cleaning performance. In some embodiments, the compact and integrated configuration of apparatus 100 may reduce installation footprint and facilitate maintenance within space-constrained car wash systems.

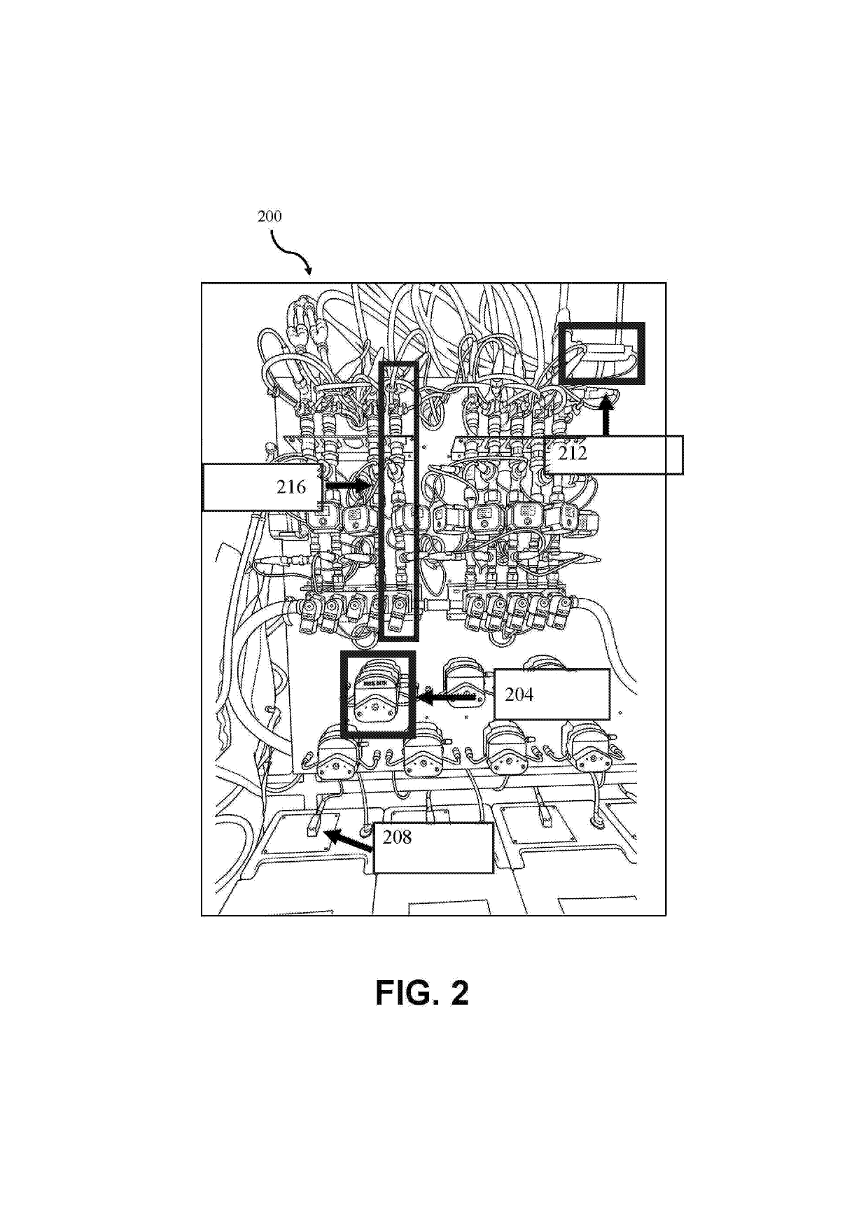

Referring now to FIG. 2, an exemplary embodiment of dispensing system 200 is described. In one or more embodiments, dispensing system 200 may include peristaltic pumps 204 configured to extract active agent from storage tanks. In one or more embodiments, dispensing system 200 may include a PH sensor 212 configured to monitor fluid entering through water solenoid. In one or more embodiments, water entering through water solenoid may contain an unexpected and/or undesired PH, wherein PH sensor 212 may be configured to identify a PH of fluid entering through water solenoid. In one or more embodiments, dispensing system 200 may include a dilution block 216. In one or more embodiments, dilution block 216 may be consistent with designated channel. In one or more embodiments, dilution block 216 may include a portion of dispensing system in which fluid and active agent are combined to create mixture. In one or more embodiments, the PH sensor 212 may be located on the water main and designed to monitor TDS and PH of incoming city water. PH sensor 212 may be positioned on the outlet of a dilution block 216 that is easily accessible as the dilution block 216 applies water to rinse the bottom of the car without soap. In one or more embodiments, dilution block 216 may be consistent with apparatus 100 and/or soap channel. In one or more embodiments, dilution block 216 may include pressure sensors, valves, flow meters, venturi valves, and/or the like. In one or more embodiments, dilution block 216 may include one or more pressure sensors, flow meters and/or valves as described in this disclosure to monitor back pressure and any potential issues. In an embodiment, sensors may be used to monitor backflow of active agent and/or fluid within dilution block 216. In one or more embodiments, a system may be configured to monitor sensors, collect a datum, and adjust flow valves, flow rates and, peristaltic pumps and/or the like accordingly. In one or more embodiments, dispensing system may include a tank level sensor 208. Tank level sensor 208 may include a sensor configured to measure an amount of active agent within each storage tank. In one or more embodiments, tank level sensor 208 may include any sensor as described in this disclosure and configured to identify an amount of active agent within storage tank. In one or more embodiments, tank level sensor may be consistent with ultrasonic sensor and/or ultrasonic level sensor as described in this disclosure.

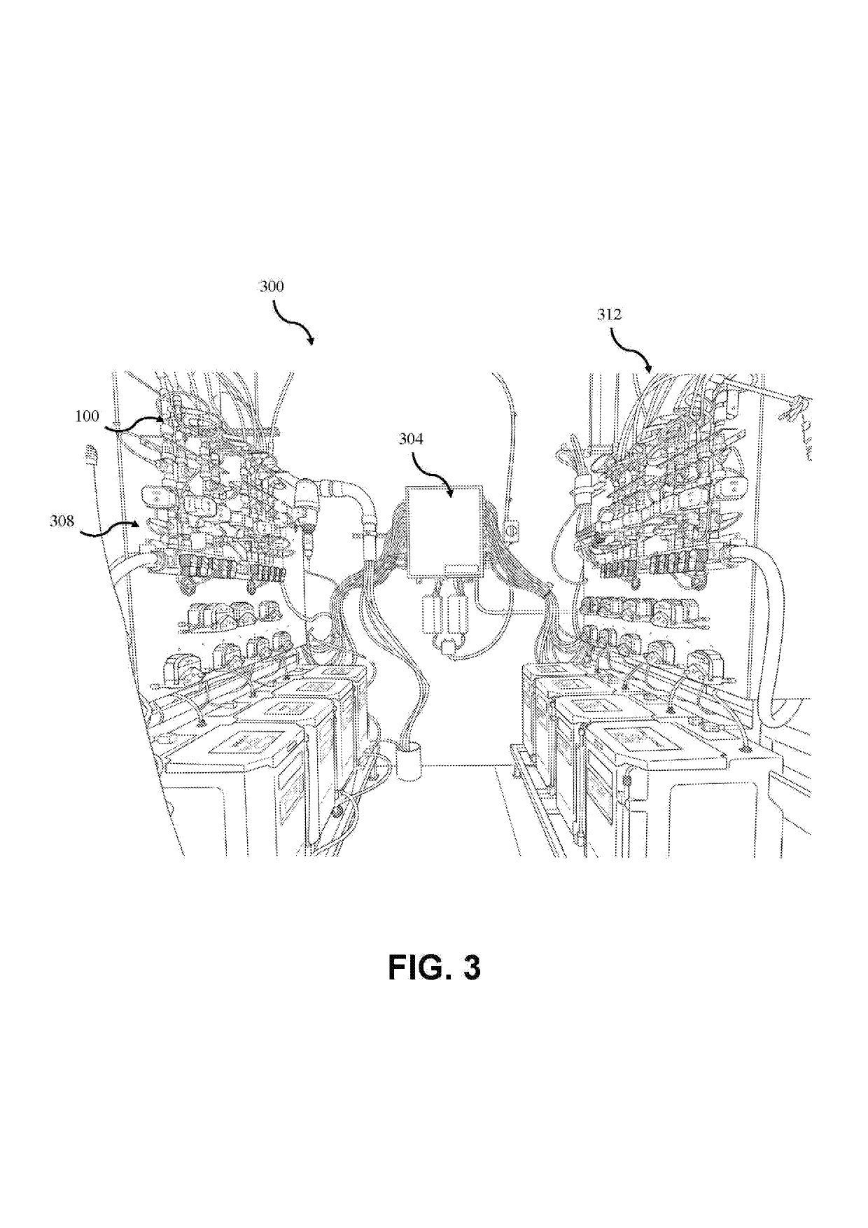

Referring now to FIG. 3, an exemplary embodiment of a dispensing station 300 is described. In one or more embodiments, dispensing station 300 may include a controller 304 communicatively connected to dispensing system. In one or more embodiments, controller 304 may include any controller as described in this disclosure.

With continued reference to FIG. 3, computing device may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” to generate an algorithm that will be performed by a Processor module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 3, system and/or controller 304 may include and/or be communicatively connected to a server, such as but not limited to, a remote server, a cloud server, a network server, and the like. In one or more embodiments. In one or more embodiments, computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by system computing device. In one or more embodiments, computing device may transmit processes to server wherein computing device may conserve power or energy.

With continued reference to FIG. 3, one or more processes as described in this disclosure may be performed by server. In one or more embodiments, processor may communicate with server to receive information needed for one or more instructions tasked by processor. In one or more embodiments, server may include one or more systems and/or software configured to provide information and/or data to processor. A “server” for the purposes of this disclosure is a system that provides resources, data, or services to other computing systems over a network. For example, without limitation, server may include a web server, a file server, a database server, and/or the like.

With continued reference to FIG. 3, controller 304 may be configured to receive a datum, or multiple datums, from pressure sensor, flow meter, and/or any other device capable of sensing a phenomenon. In one or more embodiments, controller 304 may be configured to transmit commands to dispensing system such as to valve to control fluid rate. In one or more embodiments, dispensing system may include a shut off switch. In one or more embodiments, shut off switch may allow for the immediate ceasing of electrical power to dispensing system. In one or more embodiments, dispensing station 300 may include multiple dispensing systems. In one or more embodiments, the use of multiple dispensing systems may allow for redundancy. In one or more embodiments, each dispensing system may be referred to as a ‘Skid,’ wherein a first dispensing station may be referred to as Skid 1 or a first skid 308 and a second dispensing station may be referred to as Skid 2 or a second skid 312. In one or more embodiments, dispensing station may include soap storage to hold additional soaps and/or active agents.

With continued reference to FIG. 3, in some cases, each dispensing system and/or skid may include one or more dilution blocks and/or apparatuses 100. As a non-limiting example, each dispensing system and/or skid may include a plurality of dilution blocks arranged in parallel to supply mixtures to multiple application points, or a plurality of dilution blocks arranged in series to provide staged or sequential mixing operations. In some embodiments, each dispensing system and/or skid may include dilution blocks configured to generate different ratios of fluid to active agent for different operational modes. For example, and without limitation, a first dilution block may be configured to generate a higher concentration mixture for pre-treatment, while a second dilution block may be configured to generate a lower concentration mixture for rinsing or finishing operations. In some embodiments, each dispensing system and/or skid may include dilution blocks dedicated to different active agents. For example, and without limitation, a first dilution block may be configured to dispense a cleaning agent, while a second dilution block may be configured to dispense a disinfecting agent. In some embodiments, each dispensing system and/or skid may include dilution blocks configured to operate independently or in coordination with one another. For example, and without limitation, multiple dilution blocks may be selectively activated based on operational requirements. In some embodiments, each dispensing system and/or skid may include dilution blocks configured to share one or more common resources. For example, and without limitation, multiple dilution blocks may be fluidly coupled to a common fluid supply line or may be controlled by a shared controller. In some embodiments, each dispensing system and/or skid may include dilution blocks configured to be modular and replaceable. For example, and without limitation, each dilution block may be removably connected to the dispensing system and/or skid to facilitate maintenance, repair, or replacement. In some embodiments, each dispensing system and/or skid may include dilution blocks configured to operate under different pressure or flow conditions. For example, and without limitation, a first dilution block may be configured for high-pressure operation while a second dilution block may be configured for lower-pressure operation. In some embodiments, each dispensing system and/or skid may include dilution blocks configured to integrate additional components. For example, and without limitation, each dilution block may include integrated sensors, valves, or control elements configured to enable localized control and monitoring.

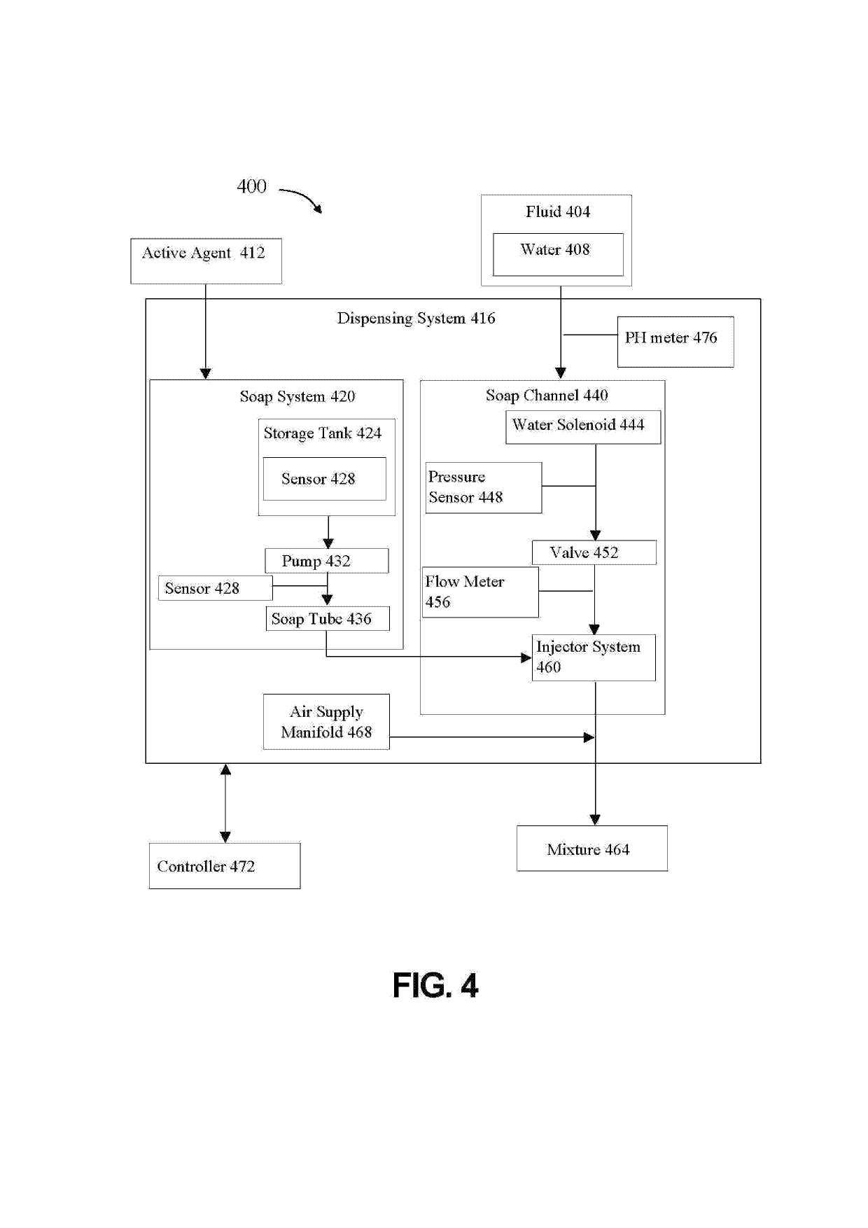

Referring now to FIG. 4, an exemplary system 400 for creating mixtures is described. In one or more embodiments, mixtures 464 may include a combination of an active agent 412 and a fluid 404 such as water 408. In one or more embodiments, active agent 412 may include a cleaning product, such as soap, a mixture of chemicals used for cleaning vehicles and/or the like. In one or more embodiments, active agent 412 may serve as the primary agent that is needed to clean a vehicle or another component. In one or more embodiments, mixtures 464 may include a combination of fluid and active agent 412 with precise amounts, such as for example, an 5% concentration of active agent 412 within fluid and/or the like.

With continued reference to FIG. 4, system 400 includes a dispensing system 416. In one or more embodiments, dispensing system 416 may include any dispensing system 416 as described in this disclosure. In one or more embodiments, dispensing system 416 includes a soap system 420. A “soap system” as described in this disclosure refers to one or more components associated with the storage and movement of active agent. In one or more embodiments, soap system 420 may include one or more storage tanks configured to store active agent 412. In one or more embodiments, active agents may be poured and/or stored within storage tanks 424 prior to use by system 400. In one or more embodiments, storage tanks 424 may include sensors 428. In one or more embodiments, sensors 428 may include any sensors a described in this disclosure. In one or more embodiments, sensors 428 utilized for storage tanks may include level sensors, ultrasonic sensors and/or the like. In one or more embodiments, sensors 428 may be used to identify a volumetric datum wherein a volumetric datum includes an amountof active agent within each storage tank. In one or more embodiments, soap system 420 further includes a pump 432. In one or more embodiments, pump 432 may include any pump as described in this disclosure such as a peristaltic pump and/or a gear pump. In one or more embodiments, pump 432 may be connected to storage tank by way of fluid connection such as through a hose and/or other piping that allows for a fluid to flow from storage tank 424 as a result of pump 432. In one or more embodiments, pump 432 may pump active agent 412 from storage tank 424 and through soap tube 436. In one or more embodiments, soap tube 436 may include any piping and/or hosing that allows for fluid to flow from storage tank 424 without leakage. In one or more embodiments, soap tube 436 may be made of a pliable material such as soft plastic, silicone and/or the like. In one or more embodiments, a sensor 428 may be located on the soap tube. In one or more embodiments, sensor 428 on soap tube may include a pressure sensor configured to detect a pressure of active agent within soap tube 436. In an embodiments, a buildup of pressure within soap tube 436 may indicate that either pump 432 is working too hard such that there is buildup, soap tube 436 has been degraded and therefore flow rate has decreased and/or some other blockage down the line is causing a buildup of active agent 412 within soap tube 436 or that downstream backpressure on output has caused the venturi’s inlet pressure to reverse, eliminating the suction we expect during normal operation.

With continued reference to FIG. 4, dispensing system 416 further includes a soap channel 440. Soap channel 440 includes any soap channel as described in this disclosure. In one or more embodiments, soap channel may be configured to route fluid 404 through soap channel which may then be used to mix with active agent 412. In one or more embodiments, an inlet of soap channel may include a water solenoid 444. In one or more embodiments, water solenoid may include any solenoid 444 as described in this disclosure. In one or more embodiments, fluid 404 may be received from a city water line, a water tank connected to dispensing system 416 and/or the like. In one or more embodiments, water solenoid may control a flow of fluid 404 into dispensing system 416. In one or more embodiments, water solenoid may be configured to provide a flow of fluid 404 into dispensing system 416. In one or more embodiments, a solenoid valve such as water solenoid 444 may include an electromechanically operated valve. It may be controlled by an electric current (usually through a coil) which generates a magnetic field, causing the valve to open or close. In one or more embodiments, system 400 may include a PH meter 476. In one or more embodiments, PH meter 476 may be configured to identify a PH of fluid 404 prior to entry within soap channel. In one or more embodiments, information from PH meter may be transferred to a computing device, wherein the computing device (such as a controller as described in this disclosure) may be configured to identify a PH of the fluid and determine if the fluid is suitable for use. In an embodiment, a fluid containing a differing PH may interact negatively with active agent 412.

With continued reference to FIG. 4, soap channel further includes a valve 452. In one or more embodiments, valve 452 may include any valve as described in this disclosure. In one or more embodiments, valve 452 may be configured to control a flow or flow rate for fluid through soap channel 440. In one or more embodiments, valve may be electromechanically operated, wherein valve 452 may be operated through the use of commands transmitted by a controller 472. In one or more embodiments, soap channel 440 may contain a pressure sensor 448 situated prior to valve and after water solenoid. In one or more embodiments, pressure sensor 448 may monitor a pressure of fluid exiting water solenoid 444 and entering valve 452. In one or more embodiments, pressure sensor may be used to identify pressure drops from fluid entering through water solenoid. In one or more embodiments, fluid from valve 452 may flow through soap channel 440. In one or more embodiments, a flow meter 456, such as any flow meter as described in this disclosure may be configured to monitor a flow rate or fluid after valve 452. In one or more embodiments, a flow rate of fluid 404 may decrease due to constrictions in flow rate placed by valve 452. In one or more embodiments, flow meter 456 may be used to ensure a proper flow rate through soap channel 440.

With continued reference to FIG. 4, soap tube may be fluidly connected to soap channel 440. In one or more embodiments, soap tube may be fluidly connected to soap channel such that active agent may flow from soap tube and into soap channel.

With continued reference to FIG. 4, soap channel 440 further includes an injector system 460. Injector system 460 includes any injector system as described in this disclosure. In one or more embodiments, injector system 460 may include a venturi valve configured to create a pressure differential that can be used to draw active agent from soap tube and into soap channel. A Venturi valve works by using the principles of fluid dynamics, specifically, the Venturi effect, to create a pressure differential that can be used to draw in active agent into a fluid stream of fluid 404. Inside the Venturi valve is a specially shaped passage that narrows in the middle and then widens again, forming three sections: the inlet, the throat, and the outlet. As fluid 404 enters the valve through the inlet, it flows into the throat, which is the narrowest part. Due to the constriction, the fluid velocity increases sharply in the throat, and as a result, the static pressure drops significantly in that area. Adjacent to this low-pressure zone is a suction port, where a secondary substance, such as active agent 412 can be introduced. The drop in pressure at the throat creates a vacuum effect that pulls active agent into the main fluid flow within soap channel 440. Once inside, the two fluids mix and continue through the expanding outlet section, where the flow slows down and pressure begins to recover. In one or more embodiments, fluid 404 and active agent 412 may combine to create mixture 464 at an outlet of soap channel. In one or more embodiments, dispensing system 416 may further include an air supply manifold 468, wherein the air supply manifold is configured to supply air to the fluid and active agent combination in order to create mixture 464 having air bubbles and/or foamy properties. In one or more embodiments, air distribution subsystem may allow for mixture to contain foamy properties and this allow for a better solution used to clean vehicles.

With continued reference to FIG. 4, system 400 includes a controller 472. Controller 472 includes any controller as described in this disclosure. Controller 472 may be configured to receive a datum from sensors 428, pressure sensors, flow meters and/or the like in order to ensure that system 400 is working properly. In one or more embodiments, controller may be configured to increase pressure of pump 432 as a result of a decrease in active agent entering mixture 464. In one or more embodiments, controller 472 may receive flow rate of fluid within soap channel 440 from flow meter and transmit commands to valve 452 in order to adjust valve to increase or decrease flow rate. In one or more embodiments, controller may utilize sensor 428 within soap tube and sensor 428 within storage tank to identify the rate at which active agent is entering soap channel. This may be done by identifying a change in volume of storage tank using sensor and/or identifying a flow rate of soap using sensors within soap tube 436. In one or more embodiments, controller 472 may use a flow rate of active agent 412 and a flow rate of fluid as identified by flow meter 456 to identify a concentration of active agent within mixture 464. In one or more embodiments, changes in concentration may indicate fluid buildup and/or issues with system 400. In one or more embodiments, dispensing system 416 may include a plurality of soap channels 440 and a plurality of soap systems 420, wherein each soap system 420 may contain a correlated soap channel 440. In one or more embodiments, dispensing system 416 may contain a plurality of soap systems 420, wherein each soap system may be configured for a differing active agent, such as for example, an active agent used for windows of a vehicle, an active agent used for cleaning tires, an active agent used for cleaning various portions of the car and/or the like. In one or more embodiments, controller may be configured to monitor each soap system 420 and each soap channel 440 in order to modify and/or adjust flow rates accordingly. In one or more embodiments, system 400 and/or dispensing system 416 may contain redundant components all connected to the same outlet. For example and without limitation, system 400 may include more than one dispensing systems 416, wherein the more than one dispensing systems 416 may be used to ensure that mixture may flow in the event of a failure within a first dispensing system 416. In one or more embodiments, each dispensing system 416 may be connected to the same or similar outlet, such that mixture may be created within either dispensing system 416 and reach the same location.

With continued reference to FIG. 4, controller 472 may be configured to adjust flow rates of fluid and/or active agent in order to ensure proper concentration within mixture 464. In one or more embodiments, controller 472 may identify concentration of mixture by receiving a flow rate from flow meter 456 and calculating flow rate of active agent using sensor within soap tube and/or sensor within storage tanks. In one or more embodiments, controller 472 may adjust flow rates my increasing a power input of peristaltic pump and thus increasing a flow rate of active agent. In one or more embodiments, controller may identify a flow rate of active agent and increase or decrease power to peristaltic pump in order to adjust flow rate due to degradation of one or more components. In one or more embodiments, controller may further be configured to adjust valve, such that a flow rate of fluid may increase or decrease in order to maintain a desired dilution ration between active agent and fluid within mixture.

With continued reference to FIG. 4, controller 472 may be configured to identify tube degradation within system 400. “Tube degradation” as described in this disclosure refers to the capability of an object to continue transfer fluids. For example, and without limitation, soap tube may be configured to navigate active agent to soap channel. However, if soap tube has become degraded, soap tube may lack the ability to continue to transport active agent at the desired flow rate under the same conditions. In one or more embodiments, controller 472 may be configured to identify a tube degradation, wherein the tube degradation indicates the capability of a tube to transport a fluid such as fluid 404 and/or active agent. In one or more embodiments, tube degradation may be measured in maximum flow rate, a percentage in comparison to an ideal tube and/or the like. In one or more embodiments, tube degradation may be measured in terms of pressure needed by peristaltic pump to increase flow rate. In one or more embodiments, tube degradation may be measured in terms of increased power output of one or more components of system 400 needed in order to maintain the same or similar flow rate. For example, tube degradation may be measured at 120%, wherein an increase of 20% of power output may be needed to maintain the desired flow rate. In one or more embodiments, a pump may be operated by a stepper motor wherein RPM of the pump is a known valve. In one or more embodiments, controller 472 may identify tube degradation by comparing an actual flow rate to an expected flow rate. An “actual flow rate” as described in this disclosure refers to a flow rate that has been calculated based on the use of one or more sensors. An expected flow rate for the purposes of this disclosure refers to a flow rate that is expected under the current power output conditions of system 400. For example, and without limitation, actual flow rate may be determined by identifying flow rate of active agent 412 through sensors 428, by identifying flow rate of fluid through flow meter 456 and/or by identifying flow rate of mixture using a sensor located at or near mixture. In another nonlimiting example, expected flow rate may include a flow rate that is calculated based on system 400 working ideally. For example, expected flow rate may include a flow rate of 1 gallon per minute in instances in which no tube degradation occurs. In an embodiments, expected flow rate may include an initial flow rate identified by system 400 on a previous day, month year and/or the like. In one or more embodiments, expected flow rate may be stored in a database and retrieved by controller. In one or more embodiments, controller 472 may be configured to calculate actual flow rate by identifying a change in volume within storage tank and/or identifying a pressure within soap channel. In one or more embodiments, controller 472 may compare actual flow rate to expected flow rate and transmit commands to peristaltic pump, water solenoid, valve and/or other electromechanical devices in order to increase power output and thus increase to decrease flow rate. In one or more embodiments, controller 472 may identify tube degradation of system 400 iteratively and adjust power output of various components accordingly.

With continued reference to FIG. 4, in one or more embodiments, a pump may be driven by a stepper motor, allowing precise control of rotational speed (RPM), which is a known and commanded parameter. Pump output may be directly proportional to RPM, assuming consistent mechanical and fluid conditions. Over time, the tubing connected to the pump may degrade due to chemical exposure or mechanical wear, leading to a reduction in the volume of fluid displaced per revolution. This degradation results in a lower actual flow rate for a given RPM. Actual Flow rate may then be determined by monitoring the change in tank level over time during dispensing. By measuring the volume dispensed, calculated from the rate of tank level change over a known time interval, the system can assess the real output of the pump. A calibration value, referred to as “pump trim,” may be periodically updated based on this observed flow rate. The pump trim value may be applied to the calculated nominal RPM to compensate for any discrepancy between expected and actual output. This adjustment ensures accurate dosing even as tubing characteristics change. The pump trim value may be maintained through ongoing calibration and is updated continuously throughout operation. When tubing is replaced, restoring original flow characteristics, the pump trim value is reset to a nominal baseline.

With continued reference to FIG. 4, in one or more embodiments, controller 472 may be configured to store actual and expected flow rates on database. In one or more embodiments, controller 472 may be configured to identify a change in tube degradation over time by plotting actual and expected flow rates over time. In one or more embodiments, controller may be configured to predict tube degradation and/or change in tube degradation over time by identifying trends in changes to expected and actual flow rates. Similarly, controller may be configured to identify component degradation wherein component degradation includes the ability of a component of system 400 to work properly. In one or more embodiments, component degradation may include identification of a valve that does not work properly, identification of injection device not working properly and/or beginning to degrade. In one or more embodiments, controller 472 may be configured to modify power output to one or more components of system in order to adjust for component degradation. In one or more embodiments, controller 472 may be configured to predict degradation of components by identifying trends in actual vs expected flow rates. In one or more embodiments, controller 472 may be configured to notify a user such as through a remote device, when a component has degraded and/or when a component is expected to require replacement due to degradation. In one or more embodiments, changes in environmental pressure, temperature and/or the like may affect flow rates. In one or more embodiments, controller 472 may be configured to identify expected vs actual flow rates and adjust accordingly due to changes in the surrounding environment. For example, and without limitation, on a hotter day, actual flow rates may differ. In one or more embodiments, controller may use linear models and/or machine learning model to calculate and/or predict component degradation and/or tube degradation. In one or more embodiments, a surrounding environment of system 400 may affect flow rates and/or dilution ratios. In one or more embodiments, factors affecting dilution ratios may include changes in humidity, changes in temperature, changes in PH of the fluid entering system, changes in chemicals within fluid entering system and/or the like. In one or more embodiments, controller may identify changes in flow rate that may emanate from environmental factors, wherein controller may adjust peristaltic pump and/or valve to ensure a desired dilution ratio between active agent and fluid. In one or more embodiments, controller may be configured to identify tube life estimation, wherein tube life estimation includes an indication on how long a tube can be used until it required replacement. In one or more embodiments, controller 472 may use changes in tube degradation to calculate tube life estimation.

With continued reference to FIG. 4, soap system 420 and/or storage tank 424 may be configured to store active agents, such as active agents utilized for washing bugs off of vehicles. In one or more embodiments, active agent 412 may include a bug remover pre-treatment for a vehicle. In one or more embodiments, the bug remover pre-treatment may include on or more chemicals designed to break down and loosen the proteins, sugars, and acids in bug splatter so they can be rinsed away more easily. In one or more embodiments, the pre-treatment may include alkaline surfactants, to break down organic matter such as bugs and tree sap. In one or more embodiments, the pre-treatment may include citrus-based solvents, used to cleaning as well. In one or more embodiments, the pre-treatment may further include enzymatic cleaners used to help digest organic matter. In one or more embodiments, soap system 420 may be configured to store active agent 412 such as pre-treatment in order to utilize active agent 412 for cleaning a vehicle. In one or more embodiments, active agent 412 may be diluted with fluid, such as water 408 and navigated downstream to a car washing device. In one or more embodiments, the car washing device may include pumps, tubing and/or the like configured to expel the mixture 464 at a high pressure.

With continued reference to FIG. 4, in one or mor embodiments, system 400 may be activated and/or deactivated through the use of external devices. An “external device” for the purposes of this disclosure is a device separate from system 400 that is configured to communicate with system 400. For example, and without limitation, external device may include a remote device, such as a smart phone, wherein the smart phone maybe configured to initiate system 400 and allow for active agent 412 to be pumped through system and thus mixture 464 is created. In one or more embodiments, external device may include pressure sensors within a car wash tunnel, wherein engagement of the pressure sensors by a vehicle, may indicate to system 400 to initiate pumps, water manifolds, and/or the like in order to create mixture 464 and navigate mixture 464 through system 400 and into car wash tunnel onto vehicle. In one or more embodiments, external device may include ultrasonic sensors, pressure sensors and/or any other sensors configured to identify the presence of a vehicle. In one or more embodiments, external devices may be used to initiate system 400 and communicate with controller to initiate generation of mixture 464.

With continued reference to FIG. 4, in one or more embodiments, aspects of the present disclosure may allow for dilution adjustment. Dilution adjustment is achieved through digital control of water and chemical flow rates using a remote device communicatively connected to controller 472. Controller may receive input from a user via a graphical user interface (GUI). The GUI may be presented on a remote device, such as a smart phone, laptop and/or the like. In one or more embodiments, the GUI may present interactive sliders that correspond to dilution ratio settings. These inputs may be transmitted wirelessly or via a local network (e.g., Wi-Fi, Ethernet) to controller. The controller then adjusts either digital proportional valves or pump speeds, depending on the hardware configuration, to alter water and soap flow rates entering a venturi or mixing chamber. The adjustments may be performed in real time while the operator observes the output directly in the wash tunnel, enabling immediate response to desired changes in mixture characteristics. The GUI may be developed using common web-based frameworks and served from an embedded HTTP server within the control unit.

With continued reference to FIG. 4, system 400 may include a tank level sensor, typically an ultrasonic, capacitive, or float-type sensor, installed in the soap reservoir within storage tank. This sensor may continuously report the fluid level to controller. Expected consumption rate is calculated based on known operational parameters such as pump RPM, commanded duty cycles, and dispensing intervals. Controller may compare the real-time rate of level depletion against the calculated expected rate over fixed time windows. If the observed depletion rate significantly exceeds the expected rate, controller may flag a discrepancy indicating a possible major leak. This function may use a time-weighted moving average algorithm or threshold-based logic to avoid false positives from minor variations. Leak detection logic runs continuously and logs data to support diagnostics.

With continued reference to FIG. 4, coil current monitoring may be implemented by integrating current-sensing circuitry into the power lines supplying solenoid valves and stepper motor drivers. This may be typically done using Hall-effect current sensors, low-resistance current shunt monitors, or integrated motor driver feedback signals. The current draw may be sampled at a fixed frequency by an analog-to-digital converter and processed by controller 472 to identify electrical characteristics such as normal energizing current, open coil (zero current when commanded on), or short circuit (excessive current). For stepper motors, this monitoring can also reveal mechanical stalling, cable faults, or partial winding failures. Current profiles may be stored and compared against known operational baselines, and any deviations outside pre-defined bounds can trigger diagnostics or alerts.

With continued reference to FIG. 4, a diagnostic system may operate on controller 472 wherein the diagnostic system continuously collects data from sensors (e.g., pressure sensors, flow sensors), electrical inputs (e.g., valve states, motor currents), and logic conditions (e.g., command status vs. sensor feedback). It executes rule-based logic trees or conditional decision trees where individual fault criteria are evaluated in real time. For example, if outlet pressure sensors report values exceeding 20 psi while the water valve control signal is off and the valve coil current is measured at zero, the system infers a mechanical failure in the valve (stuck open). Each diagnostic rule has a unique identifier that corresponds to a fault code. These fault codes are logged, timestamped, and optionally displayed via a user interface or exported to maintenance systems. Diagnostic rules are defined using condition sets with logical operators and can be updated via firmware.

With continued reference to FIG. 4, Quick-disconnect fittings may be implemented using standardized push-to-connect or twist-lock connectors placed at critical junctions in a dilution channel, soap channel and/or designated channel fluid pathway. These fittings allow for tool-less disconnection and reconnection of tubing, simplifying maintenance tasks such as tubing replacement, venturi cleaning, or chemical flushing. Material selection for these fittings must consider chemical compatibility (e.g., using EPDM, Viton, or polypropylene) and pressure rating consistent with the system’s operating parameters. Fittings may also be installed with locking clips or retention mechanisms to prevent accidental disconnection under pressurized conditions. Integration of flow shutoff valves directly into the fittings is also possible, allowing automatic sealing of lines when disconnected.

With continued reference to FIG. 4, in one or more embodiments, a positive displacement gear pump may replace the peristaltic pump, delivering chemicals and/or active agents at a regulated high pressure of approximately 75 psi. This pressure is sufficient to overcome backpressure and to inject the chemical directly into a pressurized water line without relying on venturi suction. The mixing point consists of a T junction where water and chemical converge. A check valve is installed on the chemical line at the T junction to prevent backflow into the gear pump when water pressure exceeds chemical line pressure. Flow regulation is controlled by the gear pump speed, set via a variable-frequency drive or electronically controlled motor. This configuration simplifies the fluid circuit and enables high-precision dosing by directly metering chemical volume per pump revolution, leveraging the consistent output characteristics of gear pumps.

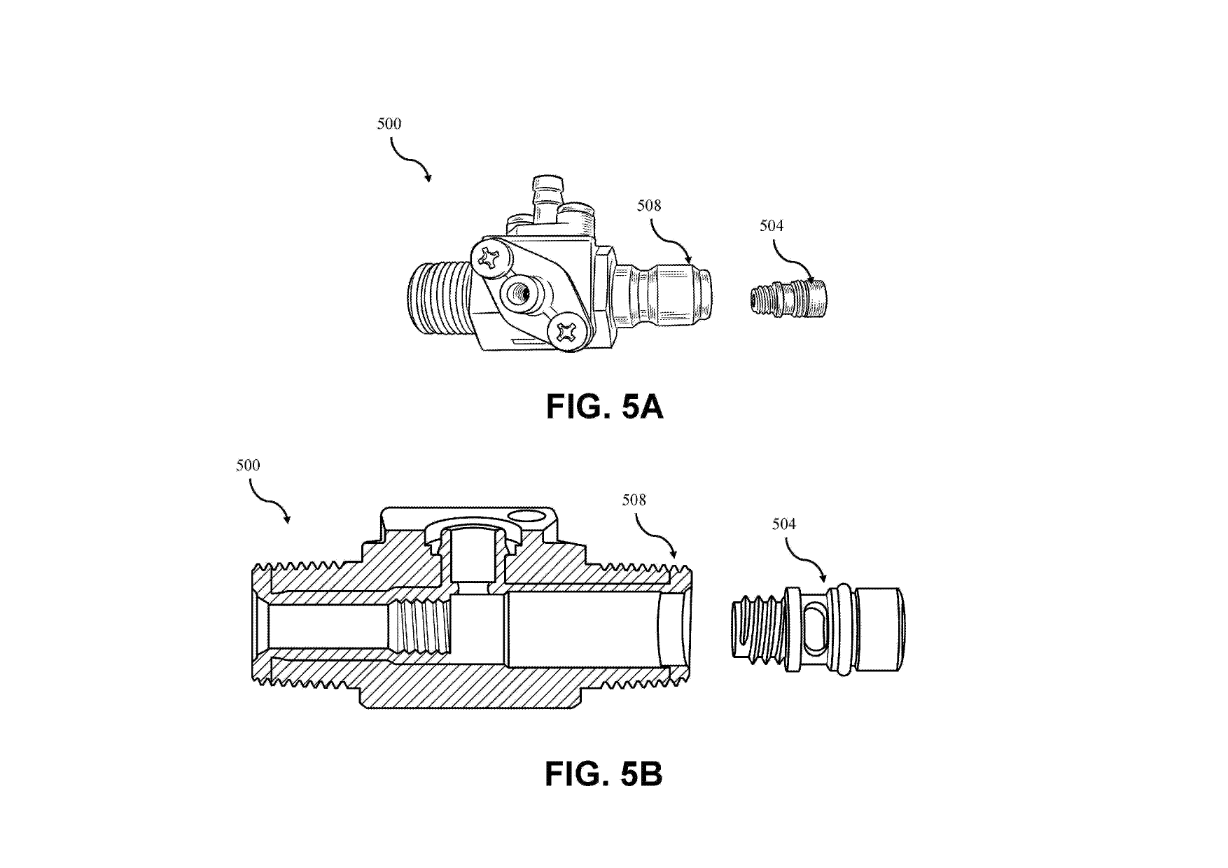

Referring now to FIGS. 5A, an exemplary embodiment of an injector system 500 is described. In one or more embodiments, injector system 500 may include any injector system 500 as described in this disclosure. In one or more embodiments, injector system 500 may be used to combine a mixture of fluid and active agent such as soap and water. In one or more embodiments, injector system 500 may create a negative pressure differential within soap tube, such that active agent within soap tube is pulled into soap channel. In one or more embodiments, injector system 500 includes a venturi valve. A Venturi valve operates based on the principle of fluid dynamics in which a fluid's velocity increases as it passes through a constricted section of pipe, causing a drop in pressure. The valve contains a tapered internal chamber that begins with a wider inlet, narrows at the center, and then widens again at the outlet. This narrowing is known as the venturi nozzle 504, and at its most restricted point lies the venturi nozzle orifice 508, which is a precisely sized opening that controls the rate at which pressure drops, and suction occurs. As fluid, typically water, flows through the valve and into the venturi nozzle 504, its speed increases at the venturi nozzle orifice 508, and static pressure decreases sharply at that point. This low-pressure zone is positioned near a side port or inlet, which allows another fluid, such as active agent to be drawn into the main flow (e.g., soap channel) from the soap tube due to the pressure differential. The active agent enters the stream of fluid through a suction port on soap channel and is mixed with the moving water in the widening section beyond the venturi nozzle orifice 508. The overall structure ensures that once initiated, this process continues as long as flow is maintained, with no moving parts required for the suction and mixing action. In one or more embodiments, use of a venturi nozzle 504 may allow for a system to utilize the energy of flowing water to pump active agent through soap tube. In one or more embodiments, the negative pressure differential within soap tube may ensure that peristaltic pump does not need to increase work to ensure that active agent is pumped through soap tube. In one or more embodiments, injector system 500 may reduce pressure placed on peristaltic pump and thereby increase a lifespan on peristaltic pump.

With continued reference to FIG. 5A, in some embodiments, injector system 500 may comprise a venturi-based structure disposed within designated channel, wherein fluid is configured to flow through the injector system 500 from an upstream portion to a downstream portion to create a localized pressure differential. In some embodiments, injector system 500 may include a metering portion corresponding to a reduced-diameter region configured to control flow characteristics and generate a suction force. For example, and without limitation, the metering portion may correspond to a throat region of a venturi that increases fluid velocity and reduces pressure to draw an active agent into designated channel. In some embodiments, injector system 500 may be configured such that the active agent is introduced at an angle relative to a primary flow direction. For example, and without limitation, the active agent may be introduced through a port oriented approximately perpendicular to the primary flow path. In some embodiments, injector system 500 may include a removable or serviceable insert corresponding to the venturi structure, wherein the insert may be secured within manifold body 104 using a sealing element. For example, and without limitation, the injector system 500 may include a removable venturi component that is retained within manifold body 104 and sealed using an O-ring or O-wrench to prevent leakage. In some embodiments, injector system 500 may be configured to cooperate with a check valve structure associated with an active agent inlet to permit ingress of the active agent under suction conditions while preventing exposure of upstream components to pressure within designated channel.

Referring now to FIG. 5B, an exemplary embodiment of a cross-sectional view of the injector system 500 is described. The injector system 500 may include a venturi nozzle orifice 508 and a venturi nozzle 504.

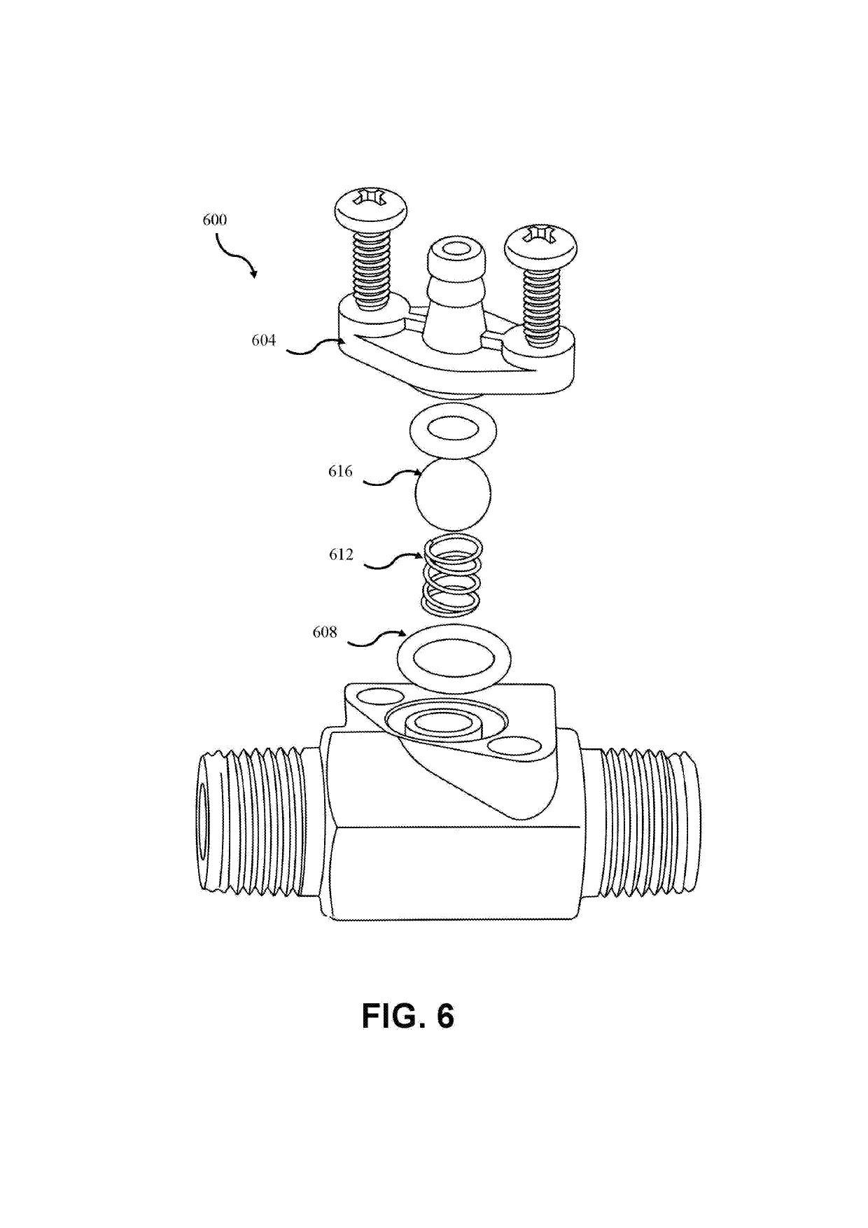

Referring now to FIG. 6, an exploded view of injector system 600 is described. In one or more embodiments, injector system 600 includes a barb 604, O-ring 608, spring 612, and ball 616. The components of injector system 600 create an internal check valve and active agent draw system. The barb 604 is a ribbed connector that allows secure attachment of the soap tube. the barb 604 ensures a tight seal and prevents the tubing from slipping off under suction. Just inside the injector body, the O-ring 608 sits around the inlet and provides a watertight seal between the barb 604 fitting and the injector housing, preventing leaks and maintaining proper suction pressure. The spring 612 and ball 616 form a one-way check valve mechanism. The ball 616 rests against a seat inside the injector, held in place by the spring 612. When the water flow through the injector creates a vacuum at the soap inlet port, the differential pressure lifts the ball 616 off its seat, compressing the spring 612 and allowing chemical to be drawn in through the barb 604. When the system stops or backpressure is present, the spring 612 pushes the ball 616 back into place, sealing the port and preventing water or active agent from flowing backward into the storage tank.

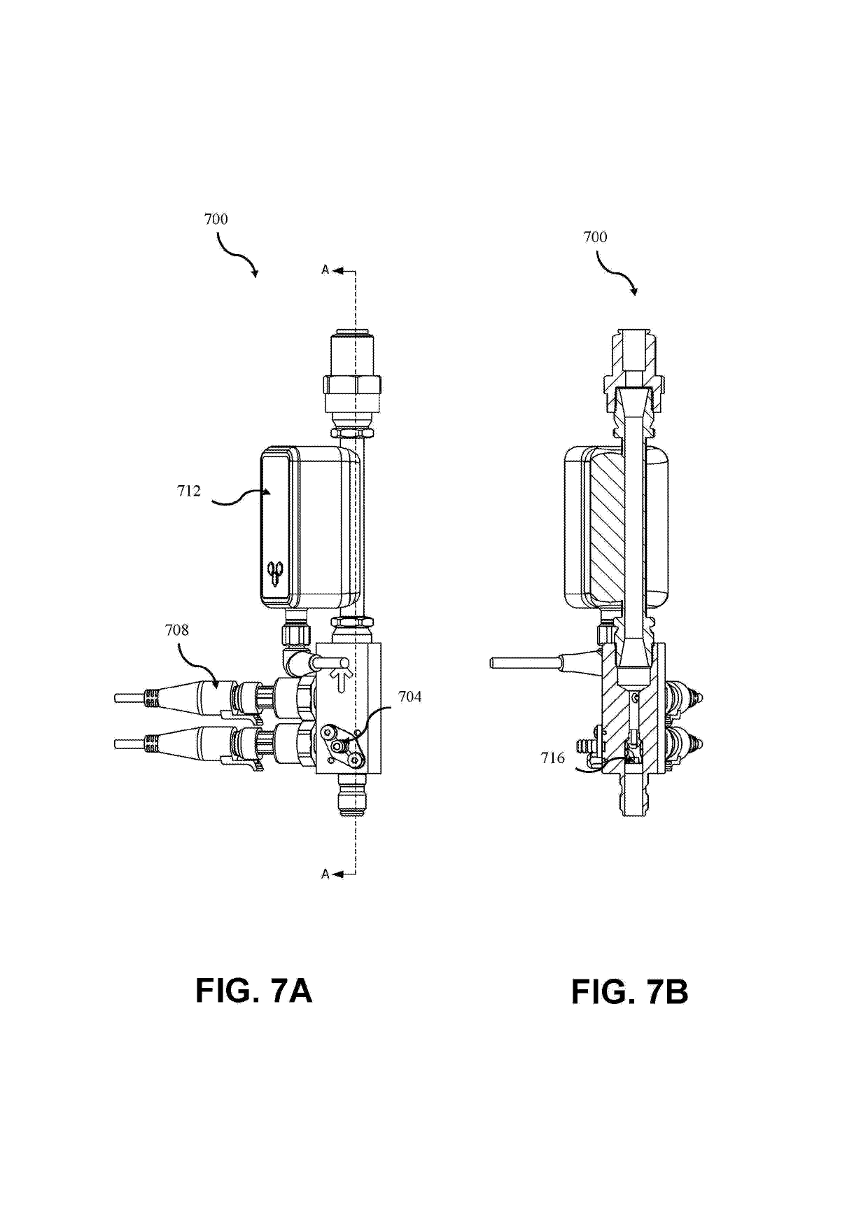

Referring now to FIGS. 7A-B , an exemplary embodiment of a soap channel 700 is described. FIG. 7A illustrates the soap channel and FIG. 7B illustrates a cross sectional view of the soap channel. In one or more embodiments, soap channel 700 may include a designated channel in which water or a fluid enters an inlet of designated channel and a mixture of water and active agent exit through an outlet of designated channel. In one or more embodiments designated channel may include a portion of an ultrasonic flow sensor. In one or more embodiments, some ultrasonic flow meter design, particularly in-line flow meters, a sensor comes with a built-in pipe section already integrated into the device. As a result, designated channel may be integrated into the flow meters wherein the built-in pipe may include designated channel and/or a portion thereof. This means the flow meter is not just attached to designated channel, but it is part and/or a portion of the designated channel. Fluid flows through the internal passage of the designated channel, wherein designated channel may be connected as a medium through which fluid flows through dispensing system. Inside an integrated section, ultrasonic transducers are positioned to send and receive sound waves across the flow of fluid with designated channel. These waves travel diagonally or directly through the liquid inside the built-in pipe. By measuring how long it takes for the ultrasonic signals to move from one side to the other, the flow meter determines the speed of the fluid, and from that, it calculates the flow rate. In one or more embodiments, soap channel 700 may include a soap port 704. In one or more embodiments, soap port 704 may allow for the introduction of soap and/or active agent within soap channel 700. In one or more embodiments, soap port 704 may be fluidly connected to soap tube, wherein active agent may be pumped through peristaltic pump, through soap tube and into soap port 704. In one or mor embodiments, soap channel 700 may include pressure sensors 708 configured to monitor a pressure at soap port 704. In one or more embodiments, pressure sensors 708 may indicate to controller if pressure buildup is occurring within soap part and/or within soap tube connected to soap port 704. In one or more embodiments, soap channel may include an injector system integrated into a soap channel. In one or more embodiments, flow sensor 712 may measure the flow of fluid and/or active agent in order to identify how much fluid is being utilized. In one or more embodiments, a venturi orifice 716 may be situated within a designated channel and/or piping of soap channel and configured to pull active agent through soap port 704. In one or more embodiments, flow meter may indicate a concentration of active agent within fluid by identifying an amount of water entering inlet and an amount of mixture exiting outlet. In one or more embodiments, flow rates of active agent may be monitored and/or recorded using peristaltic pump, while flow rates of fluid may be monitored using flow meter. In one or more embodiments, a flow rate from peristaltic pump and a flow rate from flow meter may be used to identify a dilution ratio. In one or more embodiments, flow meter may include a non-intrusive or clamp-on flow sensor. These sensors typically use ultrasonic or electromagnetic technology to measure flow rates without physically touching the fluid inside. In one or more embodiments, the ultrasonic flow meter may be positioned downstream of the soap mixture, active agent and/or mixture in order to avoid potential damage to the sensor due to high PH and chemicals within active agent. In one or more embodiments, ultrasonic flow sensor and/or flow meter may not contact fluid and/or fluid mixture but rather identify fluid and/or mixture through a separation, such as a wall. These sensors may include two transducers that are clamped to the outside surface of the pipe. They work by sending and receiving ultrasonic sound waves through the pipe wall and the flowing fluid inside. The time it takes for the sound waves to travel with and against the flow is measured, and the difference in transit times is used to calculate the velocity of the fluid. From there, flow rate is derived based on the pipe’s internal diameter. In one or more embodiments, flow meter may be situated external to fluid and/or mixture and identify a flow of fluid or mixture within a piping. In one or more embodiments, water flow metering on soap is achieved exclusively through the venturi nozzle’s flow orifice, eliminating the need for a separate flow control valve. The orifice is precisely sized to deliver a fixed flow rate, simplifying system architecture and reducing component count. A soap port 704 sensor may be incorporated to monitor conditions that could compromise proper venturi operation. One potential issue is that if inlet water pressure drops below a critical threshold, the venturi may lose suction, resulting in a reversal to positive pressure at the chemical inlet. This condition can disrupt the intended draw of chemical concentrate and potentially force water into the chemical reservoir. Additionally, the system may encounter excessive backpressure at the outlet due to downstream restrictions such as kinked lines or clogged applicators. Under such conditions, the venturi’s suction capability can also be impaired. The soap port 704 sensor enables detection of these abnormal pressure states, ensuring operational reliability and proper dilution performance. In one or more embodiments, other embodiments as described in this disclosure may incorporate alternative flow control mechanisms or sensing strategies, depending on application requirements or system complexity.

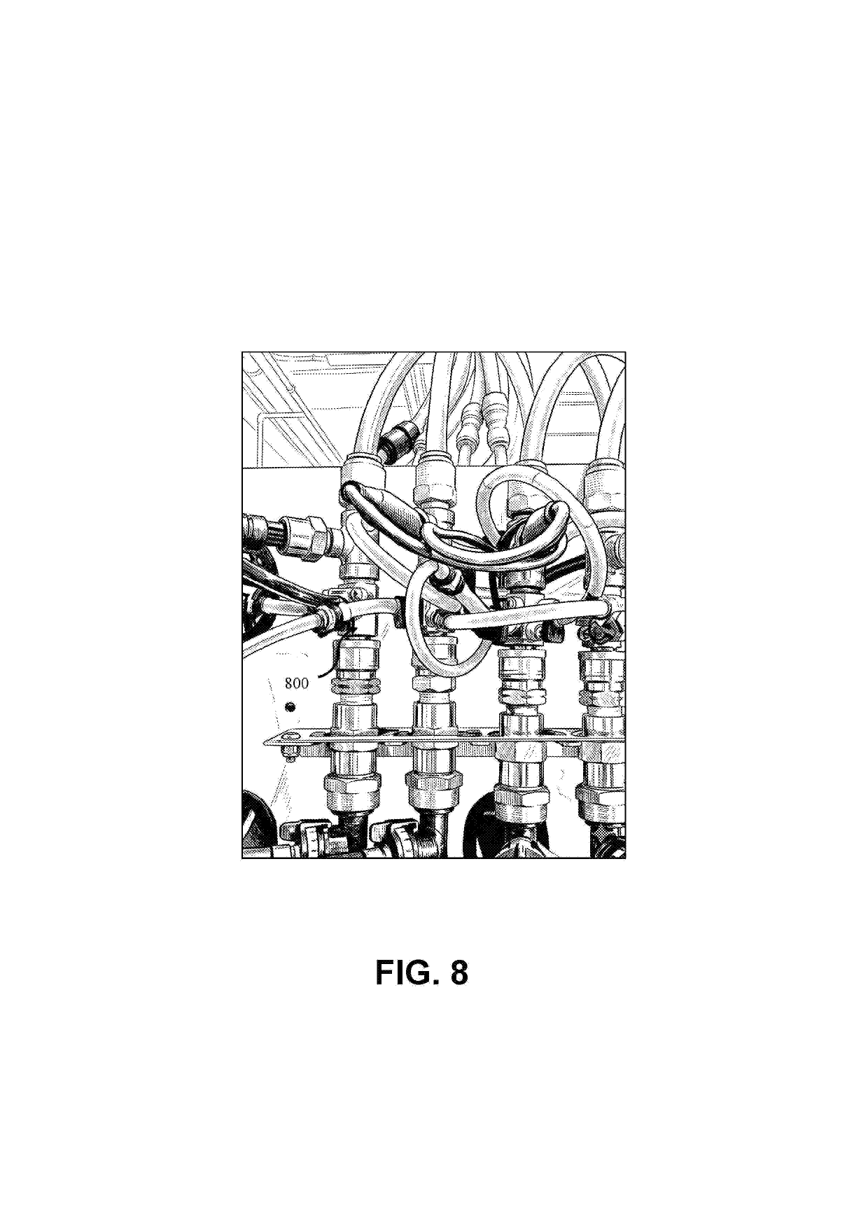

Referring now to FIG. 8, an exemplary embodiment of an injector system 800 is described. In one or more embodiments, injector system 800 includes a component configured to inject active agent into fluid within dilution block. In one or more embodiments, injector system may be consistent with dilution block as described in this disclosure. In one or more embodiments, injection system may include and/or be included within dilution block as described in this disclosure. In one or more embodiments, dilution block (as described in reference to FIG. 8 includes injector system 800. In one or more embodiments, injector system 800 may include as a venturi-based injector that uses the flow of water to draw and mix a concentrated chemical into a water stream at a specific dilution ratio. In one or more embodiments, injector system 800 is installed in a water line. As water flows through the injector, a venturi effect creates suction that pulls active agent and/or soap from a storge tank and/or from peristaltic pump. The active agent is mixed with water (e.g., fluid) and dispensed through a hose, sprayer, or other application tool. In one or more embodiments, injector system 800 may include a DEMA injector. In one or more embodiments, injector system 800 may be integrated within and/or a component of dilution block. In an injector system 800 such as a DEMA injector, the Venturi effect is created using a specifically shaped internal passage within the injector system 800. This passage includes a constricted throat section between two wider areas. As water enters the injector and passes through this narrowing, its velocity increases while the pressure drops significantly at the throat. This low-pressure zone is located adjacent to a soap inlet such as soap tube. Because the pressure at this port is lower than the pressure within the connected soap tube or reservoir, the pressure differential causes the active agent to be drawn into the water stream without the need for a mechanical pump. The injector’s internal check valve ensures that fluid only flows in the intended direction, preventing backflow. After the active agent is pulled in, the water and active agent l mix in the widening section beyond the throat, where velocity decreases and pressure begin to recover. This process enables continuous mixing of soap tube with water during flow. In one or more embodiments, injector system 800 may further ease pressure of peristaltic pump by extracting active agent that is present within soap tube. This reduces the stress on peristaltic pump to navigate active agent through soap tube, while the peristaltic pump (being a positive displacement pump) meters the flow rate of the active agent.

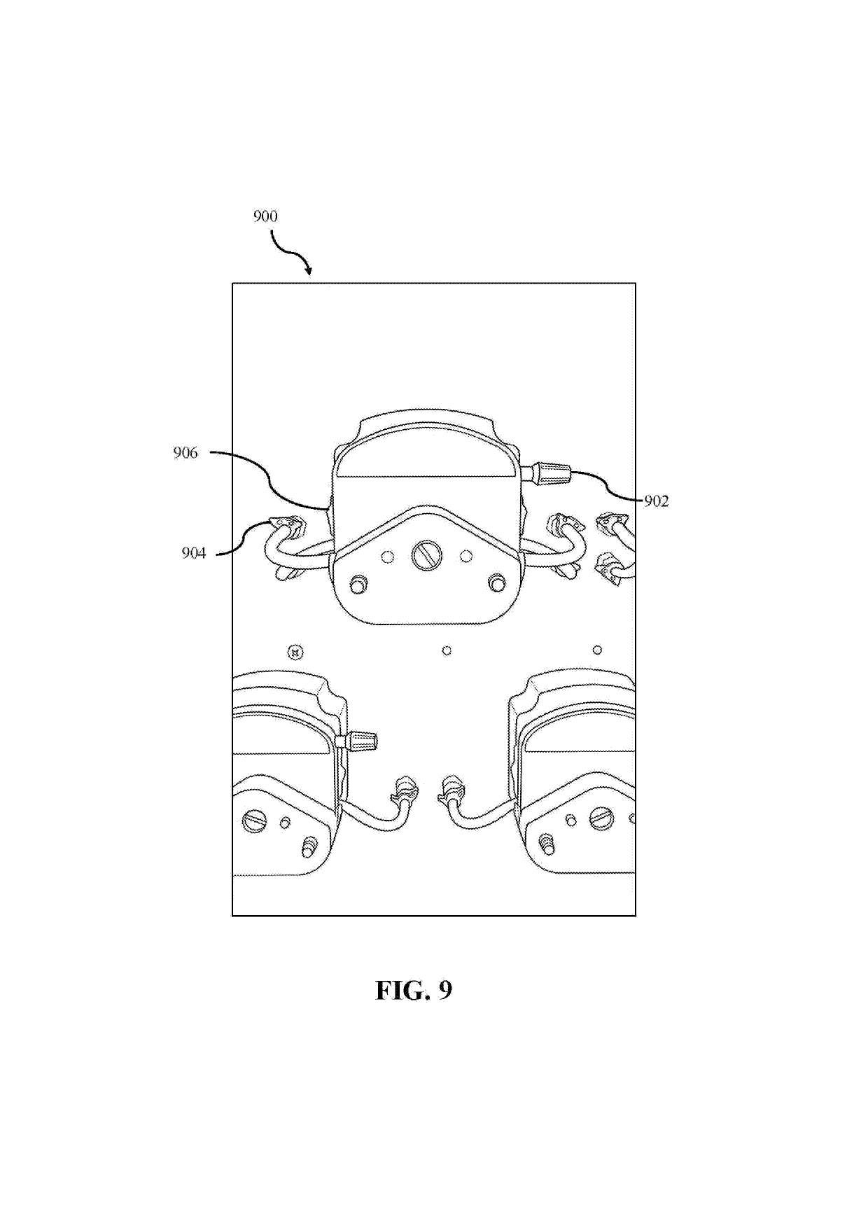

Referring now to FIG. 9, an exemplary embodiment of a peristaltic pump 900 is described. In one or more embodiments, peristaltic pump 900 may be configured to navigate active agent from storage tanks and through soap tube. In one or more embodiments, peristaltic pump 900 may operate by compressing and releasing a flexible tube to move fluid (e.g., active agent) through it in a controlled manner. In one or more embodiments, peristaltic pump 900 may include a pump head. The pump head may include the central housing where the tubing is placed and where the rollers or shoes compress the tubing to push fluid forward. In one or more embodiments, peristaltic pump 900 may include a pump tube, such as soap tube. The pump tube may include an elastomeric tube that carries the active agent. The flexibility of pump tube allows it to be repeatedly compressed and released. In one or more embodiments, peristaltic pump 900 may include a ribbed connector, typically made of plastic or metal, which secures the ends of the tubing to external supply or discharge lines. The ribs provide grip and prevent slippage when the tube is clamped. In one or more embodiments, peristaltic pump 900 may include tube clamps 904. The tube clamps 904 may include a device that holds the tube securely onto the hose barbs or within the pump housing to prevent leaks and disconnections under pressure. In one or more embodiments, peristaltic pump 900 may include a pump lever 902. The pump lever 902 may include a mechanical arm or handle used to open or close the pump head, often used to ease access when inserting or removing tubing. In one or more embodiments, peristaltic pump 900 may include a tube retainer 906. The tube retainer 906 may include small brackets or clips inside the pump head that keep the tube properly aligned and held in place during operation, preventing the tube from shifting or kinking.

With continued reference to FIG. 9, in one or more embodiments, a controller, as described in this disclosure, may be configured to execute an adaptive calibration routine to maintain the high-precision delivery of the peristaltic pump 900. This routine may calculate a “pump trim” value by correlating the commanded rotations of the pump motor with the actual volumetric displacement of the active agent as measured by the tank level sensors (e.g., via the waveguide tube). By comparing the predicted flow rate against the verified liquid depletion in the storage tank, the controller automatically adjusts the motor speed or duration to account for changes in chemical viscosity or atmospheric conditions, ensuring precise chemical ratios are maintained during the dispensing process. In one or more embodiments, the peristaltic pump 900 may be configured in dual-motor or dual-head architecture to support high-volume applications or to provide system redundancy. In this configuration, two motors may be wired in parallel to operate as a single logical unit, or a single motor may drive multiple pump heads. This parallel arrangement allows for dispensing system to meet the increased volumetric demands of specific wash cycles by delivering active agent through multiple parallel circuits simultaneously. In one or more embodiments, these dual circuits may be synchronized through a single air channel to ensure uniform delivery and foam generation across multiple applicators.

With continued reference to FIG. 9, in one or more embodiments, peristaltic pump 900 may be fluidly connected to a downstream Venturi-based dilution block. The pump may be configured to meter the concentrated active agent into the suction port of the Venturi, where it is combined with pressurized water (e.g., at approximately 150 PSI) provided by the water solenoid 96. This configuration utilizes the positive displacement characteristics of the peristaltic pump 900 to provide a consistent mass flow of chemical that is independent of the pressure fluctuations within the main water line, while the Venturi provides the high-velocity mixing and vacuum necessary for efficient foam creation. In one or more embodiments, the peristaltic pump 900 is controlled via a digital interface.

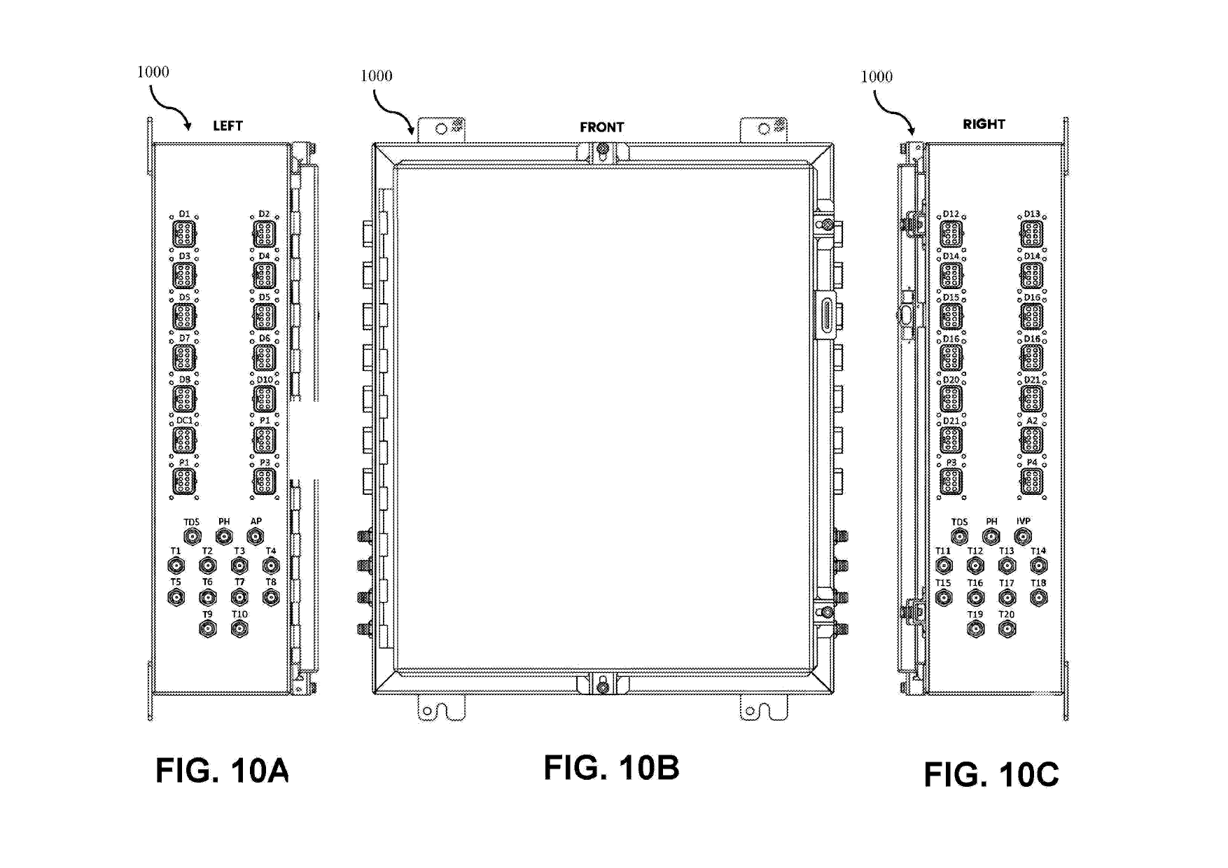

Referring now to FIGS. 10A-C , an exemplary embodiment of a controller 1000 is described. In one or more embodiments, Controller 1000 might exist as a single controller that operates both skids, or multiple controllers that exist external or internal to each skid, controlling individual skids in concert with each other, with or without orchestration by an attached server. In one or more embodiments, controller 1000 may include any controller as described in this disclosure. In one or more embodiments, controller 1000 may be communicatively connected to dispensing system and configured to receive data from dispensing system. In one or more embodiments, controller 1000 may be configured to receive information from water solenoid, pressure sensor, flow meter, outlet pressure sensor, soap pressure sensor and/or any other sensors and/or electromechanics devices. In one or more embodiments, controller 1000 may be configured to control a flow of active agent and/or fluid by manipulating valves, peristaltic pumps and/or the like. In one or more embodiments, controller 1000 may receive a datum from level sensors, pressure sensors and/or the like and generate commands to various components of dispensing system to increase pressure, increase flow rate and/or the like. In one or more embodiments, controller 1000 may be configured to communicate with a remote device to transmit notifications associated with pressure buildup, changes in flow rate, changes in PH levels and/or the like

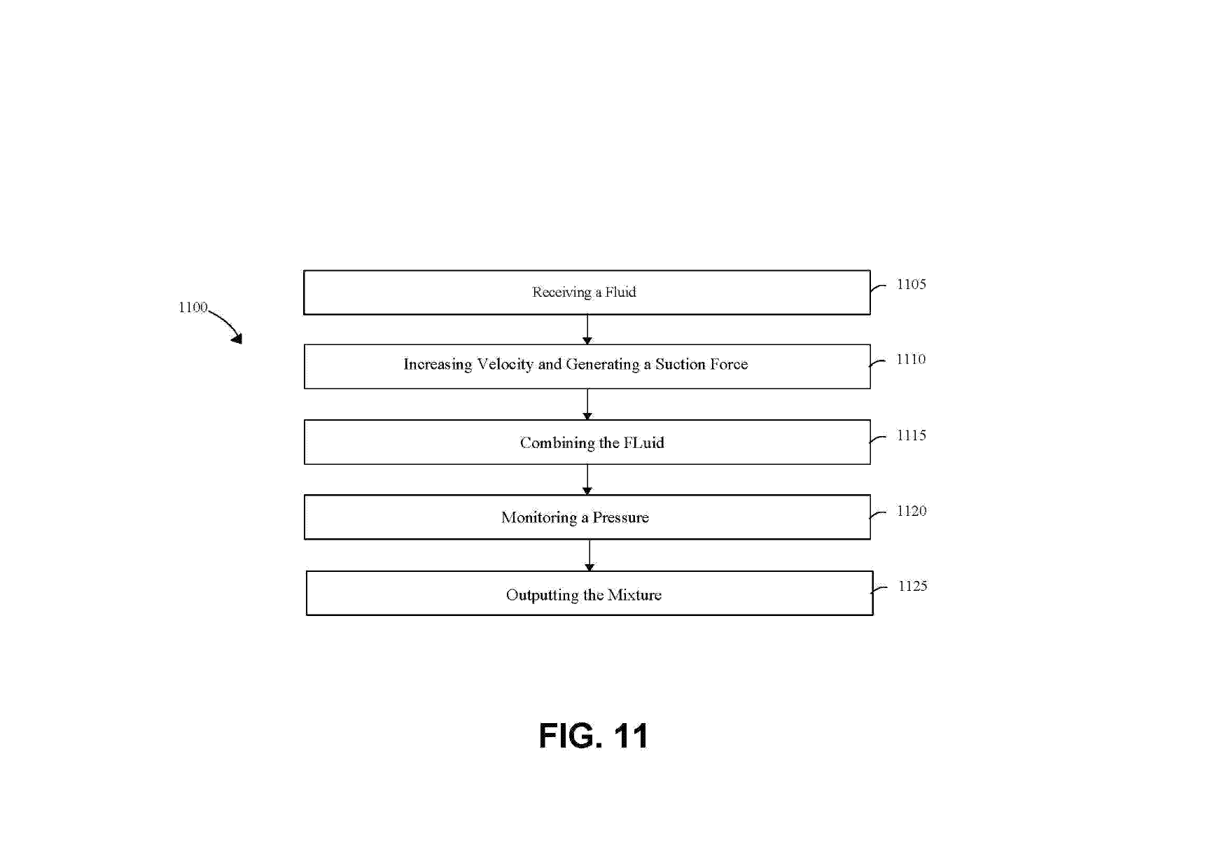

Referring now to FIG. 11, a flow diagram of an exemplary method 1100 for generating a mixture of a fluid and an active agent is illustrated. Method 100 contains a step 1105 of receiving a fluid using a manifold body defining a designated channel extending from an inlet to an outlet. This may be implemented with reference to FIGS. 1-10 and without limitation.

With continued reference to FIG. 11, method 1100 contains a step 1110 of increasing a velocity of a fluid flowing through a designated channel and generating a suction force using an injector system disposed within the designated channel. In some embodiments, increasing the velocity of the fluid may include increasing the velocity using a venturi injector of the injector system, wherein the venturi injector may include an orifice. This may be implemented with reference to FIGS. 1-10 and without limitation.

With continued reference to FIG. 11, method 1100 contains a step 1115 of combining a fluid with an active agent within a designated channel to generate a mixture. This may be implemented with reference to FIGS. 1-10 and without limitation.

With continued reference to FIG. 11, method 1100 contains a step 1120 of monitoring, using at least one pressure sensor integrated with a manifold body, a pressure within a designated channel. In some embodiments, monitoring the pressure may include monitoring, using a first pressure sensor of the at least one pressure sensor, a first pressure at the inlet, and monitoring, using a second pressure sensor of the at least one pressure sensor, a second pressure at the outlet. This may be implemented with reference to FIGS. 1-10 and without limitation.

With continued reference to FIG. 11, method 1100 contains a step 1125 of outputting a mixture at the outlet. In some embodiments, method 1100 may further include receiving the active agent at a soap port formed in the manifold body, permitting one-way flow of the active agent into the designated channel using a check valve assembly disposed at the soap port, wherein permitting one-way flow of the active agent may include preventing backflow of the fluid from the designated channel toward the soap port using a spring-biased valve of the check valve assembly. In some embodiments, method 1100 may further include regulating a flow rate of the active agent delivered to the soap port using a pump fluidly coupled to the soap port. In some embodiments, method 1100 may further include selectively providing, using a fluid providing valve, a fluid to a manifold body defining a designated channel extending from the inlet to the outlet, controlling operation of at least one of the fluid providing valve using a controller communicatively coupled to at least one of the at least one pressure sensor based on sensor data. In some embodiments, method 1100 may further include determining, using the controller, a ratio of the fluid to the active agent based on the sensor data. In some embodiments, method 1100 may further include measuring a pH of the fluid prior to entry of the fluid into the designated channel using a pH meter, determining, using a controller, whether the fluid is suitable for combination with the active agent based on the pH, and controlling, using the controller, operation of at least the fluid providing valve based on the determination. In some embodiments, method 1100 may further include removably connecting the manifold body to at least one of a fluid supply line or a downstream conduit using one or more connection interfaces formed as part of the manifold body. In some embodiments, method 1100 may further include introducing air into the designated channel using an air supply manifold such that the mixture may include air bubbles or foamed characteristics. This may be implemented with reference to FIGS. 1-10 and without limitation.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

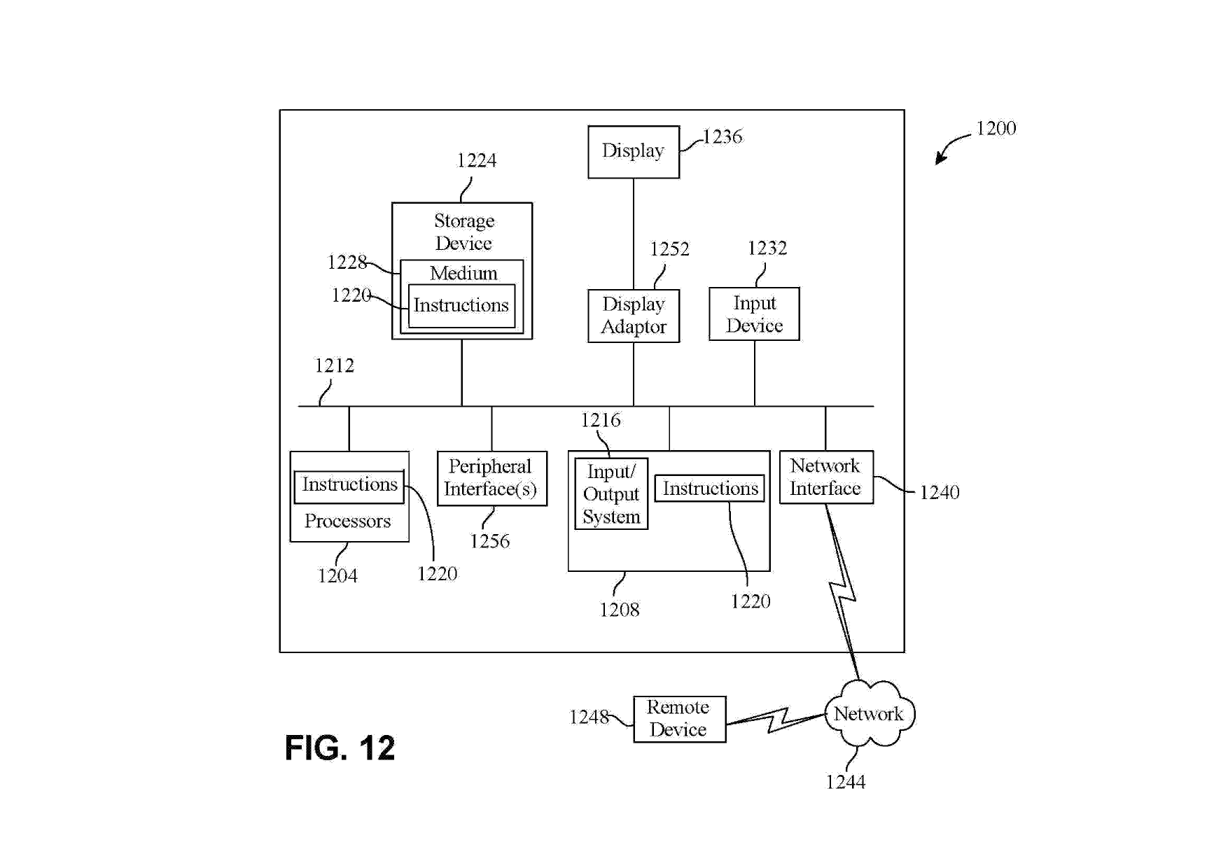

FIG. 12 shows a diagrammatic representation of one embodiment of a computing device in the exemplary form of a computer system 1200 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1200 includes a processor 1204 and a memory 1208 that communicate with each other, and with other components, via a bus 1212. Bus 1212 may include any of several types of bus structures including, but not limited to, a memory bus, a memory controller, a peripheral bus, a local bus, and any combinations thereof, using any of a variety of bus architectures.

Processor 1204 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1204 may be organized according to Von Neumann and/or Harvard architecture as a non-limiting example. Processor 1204 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1208 may include various components (e.g., machine-readable media) including, but not limited to, a random-access memory component, a read only component, and any combinations thereof. In one example, a basic input/output system 1216 (BIOS), including basic routines that help to transfer information between elements within computer system 1200, such as during start-up, may be stored in memory 1208. Memory 1208 may also include (e.g., stored on one or more machine-readable media) instructions (e.g., software) 1220 embodying any one or more of the aspects and/or methodologies of the present disclosure. In another example, memory 1208 may further include any number of program modules including, but not limited to, an operating system, one or more application programs, other program modules, program data, and any combinations thereof. Memory 1208 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1200 may also include a storage device 1224. Examples of a storage device (e.g., storage device 1224) include, but are not limited to, a hard disk drive, a magnetic disk drive, an optical disc drive in combination with an optical medium, a solid-state memory device, and any combinations thereof. Storage device 1224 may be connected to bus 1212 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1224 (or one or more components thereof) may be removably interfaced with computer system 1200 (e.g., via an external port connector (not shown)). Particularly, storage device 1224 and an associated machine-readable medium 1228 may provide nonvolatile and/or volatile storage of machine-readable instructions, data structures, program modules, and/or other data for computer system 1200. In some embodiments, storage device 1224 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software 1220 may reside, completely or partially, within machine-readable medium 1228. In another example, software 1220 may reside, completely or partially, within processor 1204.

Computer system 1200 may also include an input device 1232. In one example, a user of computer system 1200 may enter commands and/or other information into computer system 1200 via input device 1232. Examples of an input device 1232 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1232 may be interfaced to bus 1212 via any of a variety of interfaces (not shown) including, but not limited to, a serial interface, a parallel interface, a game port, a USB interface, a FIREWIRE interface, a direct interface to bus 1212, and any combinations thereof. Input device 1232 may include a touch screen interface that may be a part of or separate from display 1236, discussed further below. Input device 1232 may be utilized as a user selection device for selecting one or more graphical representations in a graphical interface as described above.

A user may also input commands and/or other information to computer system 1200 via storage device 1224 (e.g., a removable disk drive, a flash drive, etc.) and/or network interface device 1240. A network interface device, such as network interface device 1240, may be utilized for connecting computer system 1200 to one or more of a variety of networks, such as network 1244, and one or more remote devices 1248 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1244, may employ a wired and/or a wireless mode of communication. In general, any network topology may be used. Information (e.g., data, software 1220, etc.) may be communicated to and/or from computer system 1200 via network interface device 1240.

Computer system 1200 may further include a video display adapter 1252 for communicating a displayable image to a display device, such as display 1236. Examples of a display device include, but are not limited to, a liquid crystal display (LCD), a cathode ray tube (CRT), a plasma display, a light emitting diode (LED) display, and any combinations thereof. Display adapter 1252 and display 1236 may be utilized in combination with processor 1204 to provide graphical representations of aspects of the present disclosure. In addition to a display device, computer system 1200 may include one or more other peripheral output devices including, but not limited to, an audio speaker, a printer, and any combinations thereof. Such peripheral output devices may be connected to bus 1212 via a peripheral interface 1256. Examples of a peripheral interface include, but are not limited to, a serial port, a USB connection, a FIREWIRE connection, a parallel connection, and any combinations thereof.

Further referring to FIG. 12, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 12, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 12, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1200, processor 1204, and memory 1208 may be virtualized; that is, a virtual machine and/or container may interact directly with such computing system 1200, processor 1204, and/or memory 1208, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1204 comprises a plurality of processors and/or processor cores, virtualization may, in some cases, simulate or emulate a single (virtual) processor whose functions are allocated to one or more of the plurality of processors and/or processor cores. In this case, while processor 1204 may be said to be virtualized, the processor 1204, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and apparatuses according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for generating a mixture of a fluid and an active agent, the apparatus comprising:
a manifold body defining a designated channel extending from an inlet to an outlet, wherein the designated channel is configured to:
receive a fluid; and
combine the fluid with an active agent within the designated channel to generate and output a mixture at the outlet;
an injector system disposed within the designated channel, wherein the injector system is configured to increase a velocity of the fluid flowing through the designated channel and generate a suction force that draws the active agent into the designated channel; and
at least one pressure sensor integrated with the manifold body, wherein the at least one pressure sensor is configured to monitor a pressure within the designated channel.

2. The apparatus of claim 1, wherein the injector system comprises a venturi injector comprising an orifice configured to increase the velocity of the fluid flowing through the designated channel.

3. The apparatus of claim 1, wherein the at least one pressure sensor comprises:
a first pressure sensor disposed at the inlet; and
a second pressure sensor disposed at the outlet.

4. The apparatus of claim 1, wherein the apparatus further comprises:
a soap port formed in the manifold body, wherein the soap port is configured to receive the active agent, wherein a check valve assembly is disposed at the soap port and configured to permit one-way flow of the active agent into the designated channel; and
a pump fluidly coupled to the soap port, wherein the pump is configured to regulate a flow rate of the active agent delivered to the soap port.

5. The apparatus of claim 4, wherein the check valve assembly comprises a spring-biased valve configured to prevent backflow of the fluid.

6. The apparatus of claim 1, wherein the apparatus further comprises:
a fluid providing valve fluidly coupled to the inlet, wherein the fluid providing valve is configured to selectively provide the fluid to the manifold body; and
a controller communicatively coupled to at least one of the at least one pressure sensor and the fluid providing valve, wherein the controller is configured to control operation of at least one of the fluid providing valve based on sensor data.

7. The apparatus of claim 6, wherein the controller is further configured to determine a ratio of the fluid to the active agent based on the sensor data.

8. The apparatus of claim 6, wherein the apparatus further comprises:
a pH meter configured to measure a pH of the fluid prior to entry of the fluid into the designated channel, wherein the pH meter is communicatively coupled to a controller, and wherein the controller is configured to:
determine, based on the pH, whether the fluid is suitable for combination with the active agent; and
control operation of at least the fluid providing valve based on the determination of whether the fluid is suitable for combination with the active agent.

9. The apparatus of claim 1, wherein the manifold body comprises one or more connection interfaces formed as part of the manifold body and configured for removable connection of the manifold body to at least one of a fluid supply line or a downstream conduit.

10. The apparatus of claim 1, wherein the apparatus further comprises:
an air supply manifold fluidly coupled to the manifold body, wherein the air supply manifold is configured to introduce air into the designated channel such that the mixture generated at the outlet comprises air bubbles or foamed characteristics.

11. A method of generating a mixture of a fluid and an active agent, the method comprising:
receiving a fluid using a manifold body defining a designated channel extending from an inlet to an outlet;
increasing a velocity of the fluid flowing through the designated channel and generating a suction force using an injector system disposed within the designated channel;
combining the fluid with an active agent within the designated channel to generate a mixture;
monitoring, using at least one pressure sensor integrated with the manifold body, a pressure within the designated channel; and
outputting the mixture at the outlet.

12. The method of claim 11, wherein increasing the velocity of the fluid comprises increasing the velocity using a venturi injector of the injector system, wherein the venturi injector comprises an orifice.

13. The method of claim 11, wherein monitoring the pressure comprises:
monitoring, using a first pressure sensor of the at least one pressure sensor, a first pressure at the inlet; and
monitoring, using a second pressure sensor of the at least one pressure sensor, a second pressure at the outlet.

14. The method of claim 11, further comprising:
receiving the active agent at a soap port formed in the manifold body;
permitting one-way flow of the active agent into the designated channel using a check valve assembly disposed at the soap port, wherein permitting one-way flow of the active agent comprises preventing backflow of the fluid from the designated channel toward the soap port using a spring-biased valve of the check valve assembly.

15. The method of claim 14, further comprising:
regulating a flow rate of the active agent delivered to the soap port using a pump fluidly coupled to the soap port.

16. The method of claim 11, further comprising:
selectively providing, using a fluid providing valve, a fluid to a manifold body defining a designated channel extending from the inlet to the outlet;
controlling operation of at least one of the fluid providing valve using a controller communicatively coupled to at least one of the at least one pressure sensor based on sensor data.

17. The method of claim 16, further comprising:
determining, using the controller, a ratio of the fluid to the active agent based on the sensor data.

18. The method of claim 16, further comprising:
measuring a pH of the fluid prior to entry of the fluid into the designated channel using a pH meter;
determining, using a controller, whether the fluid is suitable for combination with the active agent based on the pH; and
controlling, using the controller, operation of at least the fluid providing valve based on the determination.

19. The method of claim 11, further comprising:
removably connecting the manifold body to at least one of a fluid supply line or a downstream conduit using one or more connection interfaces formed as part of the manifold body.

20. The method of claim 11, further comprising:
introducing air into the designated channel using an air supply manifold such that the mixture comprises air bubbles or foamed characteristics.
